(19) United States
(12) Patent Application Publication
(10) Pub. No.: US 2019/0018385 A1
(43) Pub. Date: Jan. 17, 2019

(54) PROGRAMMABLE LOGIC CONTROLLER, DATA COLLECTOR, AND PROGRAMMING SUPPORT APPARATUS

(71) Applicant: Keyence Corporation, Osaka (JP)

(72) Inventors: Yusuke Soneda, Osaka (JP); Kazuaki Sugimura, Osaka (JP); Yukito Minami, Osaka (JP)

(73) Assignee: Keyence Corporation, Osaka (JP)

(21) Appl. No.: 15/994,353

(22) Filed: May 31, 2018

(30) Foreign Application Priority Data
Jul. 11, 2017 (JP) 2017-135377

(51) Int. Cl. G05B 19/05

(52) U.S. Cl. CPC G05B 19/05; G05B 2219/13082

(57) ABSTRACT

To make it easy for a user to extract individual data from time series data. A programming support apparatus or a programmable logic controller (PLC) analyzes a user program to decide an extraction period of individual data. For example, in the user program, an instruction word for setting the extraction period is described. A collection part repeatedly collects device data stored in at least one device to form time series data having periodicity. An extraction part extracts individual data in each extraction period from the time series data. An addition part adds identification information for identifying each piece of the individual data extracted by the extraction part to each piece of the individual data.

### CROSS-REFERENCE TO RELATED APPLICATIONS

The present application claims foreign priority based on Japanese Patent Application No. 2017-135377, filed Jul. 11, 2017, the contents of which is incorporated herein by reference.

### BACKGROUND OF THE INVENTION

### 1. Field of the Invention

The present invention relates to a programmable logic controller, a data collector, and a programming support apparatus.

### 2. Description of Related Art

A programmable logic controller (hereinafter referred to as PLC) is a sequence controller widely used in a factory automation (FA) control system and operates in accordance with a user program such as a ladder program. An operator connects input equipment such as a limit switch, a sensor, and a thermometer, and output equipment such as an electromagnetic switch, a solenoid, a motor, an actuator, a cylinder, a relay, and a positioning system to the PLC, and controls the above equipment to be controlled by using a ladder program. The operator creates the ladder program on a programming support apparatus such as a personal computer (hereinafter referred to as PC), connects between the PC and the PLC, and stores the ladder program into a storage part of the PLC. Various pieces of data such as device information are also stored into the storage part of the PLC. The device information is information indicating a state of input from input equipment, a state of output to output equipment, and states of an internal relay (auxiliary relay) set on the ladder program, a timer, a counter, a data memory, and the like, set on the ladder program. The device is a name indicating an area on a memory, which is provided for storing the device information.

By connecting the programming support apparatus to the PLC, the device information (a value of the device) held by the PLC can be displayed on the programming support apparatus and visually recognized. The PLC is generally made up of a basic unit (CPU unit) and an extension unit. The CPU unit and the extension unit exchange device values with each other by refresh executed for each scan cycle through previously allocated devices.

Meanwhile, in order to stably produce a workpiece (part) in a workpiece production process, predictive maintenance of the production process is necessary. This is because a manufacturing machine used in the production process has a portion requiring the maintenance. In accordance with U.S. Pat. No. 9,128,472, it is proposed that an industrial machine analyzes data by transferring data to a cloud in accordance with a predetermined template.

According to U.S. Pat. No. 9,128,472, a previously prepared template is required. That is, when there is no template corresponding to the user's need, the user has to create a template himself or herself, which has been troublesome. Further, in the predictive maintenance described above, it is necessary to consider individual data corresponding to an individual part among time series data. However, with the time series data of device values being enormous, it has been difficult for the user to extract necessary individual data out of the time series data.

### SUMMARY OF THE INVENTION

Therefore, an object of the present invention is to make it easy for a user to extract individual data out of time series data.

The present invention is, for example, a programmable logic controller for repeatedly executing a user program, the controller including: a program storage part that stores the user program; a device storage part that holds a plurality of devices instructable by the user program and including a bit device for storing information of one bit and a word device for storing information of one word or several words; a program execution part that repeatedly executes the user program stored in the program storage part and performs computing processing on information stored in each of the plurality of devices in accordance with the user program; a data collection part that repeatedly collects device data stored in at least one device to form time series device data having periodicity; an acquisition part that acquires an extraction period instructed by a user in the user program; an extraction part that extracts individual data from the time series device data in accordance with the extraction period acquired by the acquisition part; and an addition part that adds identification information for identifying each piece of the individual data extracted by the extraction part to each piece of the individual data.

According to the present invention, it becomes easy for a user to extract individual data from time series data.

### BRIEF DESCRIPTION OF THE DRAWINGS

FIG. 1 is a diagram showing a PLC system;

FIG. 2 is a diagram for explaining a ladder program;

FIG. 3 is a diagram for explaining a programming support apparatus;

FIG. 4 is a diagram for explaining a PLC;

FIG. 5 is a diagram for explaining scanning of the ladder program;

FIG. 6 is a diagram for explaining an IPC;

FIG. 7 is a diagram for explaining a cloud;

FIG. 8 is a diagram for explaining time series data and an extraction period;

FIG. 9 is a diagram for explaining a description method for an extraction period;

FIG. 10 is a diagram for explaining periodicity of device values;

FIG. 11 is a diagram for explaining a description method for the extraction period;

FIG. 12 is a diagram for explaining a description method for the extraction period;

FIG. 13 is a diagram for explaining a description method for the extraction period;

FIG. 14 is a diagram for explaining functions relative to setting of the extraction period;

FIG. 15 is a diagram for explaining functions relative to data collection and extraction;

FIG. 16 is a diagram for explaining functions relative to data collection and extraction;

FIG. 17 is a diagram for explaining functions relative to data collection and extraction;

FIG. 18 is a flowchart for explaining setting processing for the extraction period;

FIG. 19 is a flowchart for explaining collection processing;

FIG. 20 is a diagram for explaining time series data;

FIG. 21 is a flowchart for explaining extraction processing;

FIG. 22 is a diagram for explaining individual data;

FIG. 23 is a flowchart for explaining integrated collection processing and extraction processing;

FIG. 24 is a view for explaining a UI that displays individual data;

FIG. 25 is a view for explaining a UI that displays individual data;

FIG. 26 is a diagram for explaining a UI that displays individual data;

FIG. 27 is a sequence diagram relative to transmission and reception of individual data;

FIG. 28 is a sequence diagram relative to transmission and reception of individual data;

FIG. 29 is a sequence diagram relative to transmission and reception of individual data;

FIG. 30 is a sequence diagram relative to transmission and reception of individual data; and

FIG. 31 is a diagram showing a display example of individual data.

### DETAILED DESCRIPTION OF PREFERRED EMBODIMENTS

### System Configuration

First, in order to enable a person skilled in the art to better understand a programmable logic controller (PLC, which may be simply referred to as a programmable controller), a configuration of a general PLC and its operation will be described.

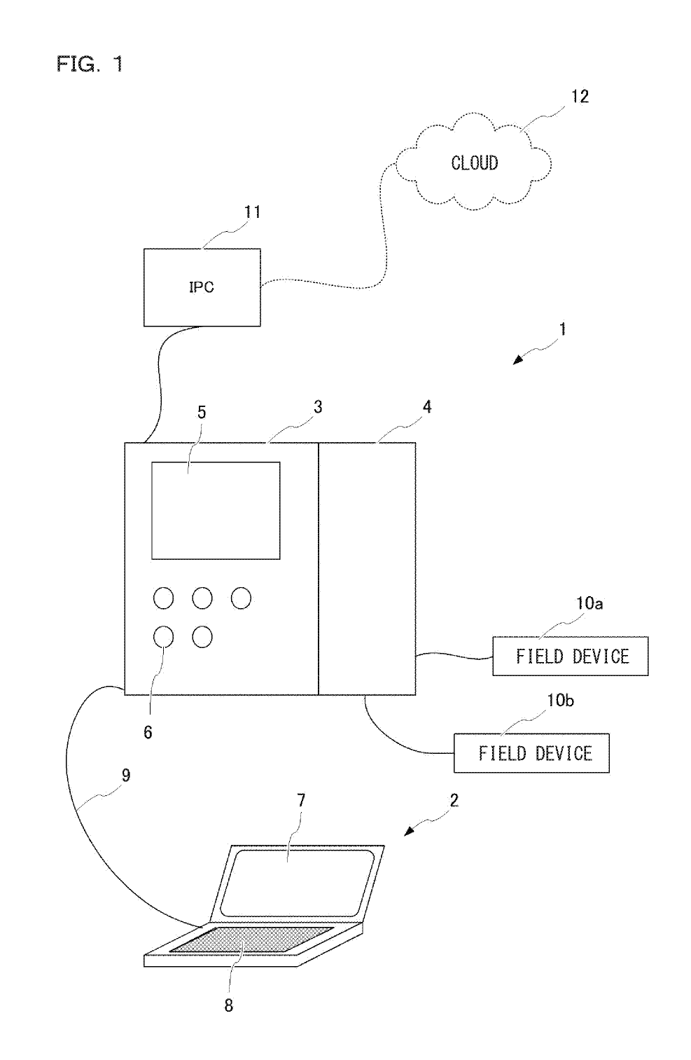

FIG. 1 is a conceptual diagram showing a configuration example of a programmable logic controller system according to an embodiment of the present invention. As shown in FIG. 1, this system includes a programming support apparatus 2 for editing a user program such as a ladder program, and a programmable logic controller (PLC) 1 for integrally controlling various controllers installed in factories and the like. The user program may be created using graphical programming language such as ladder language or a flowchart-format motion program or may be created using high-level programming language such as a C language. In the following, for convenience of description, the user program is assumed to be the ladder program. The PLC 1 includes a basic unit 3 with a built-in CPU and one or a plurality of extension units 4. One or a plurality of extension units 4 can be attached to and detached from the basic unit 3. The basic unit 3 may be referred to as a CPU unit.

The basic unit 3 is provided with a display part 5 and an operation part 6. The display part 5 can display an operation status and the like of each extension unit 4 attached to the basic unit 3. The display part 5 switches display contents in accordance with the operation contents of the operation part 6. The display part 5 normally displays a current value (device value) of a device in the PLC 1 error information generated in the PLC 1, and the like. The device is a name indicating an area on a memory provided for storing a device value (device data), and may be referred to as a device memory. The device value is information indicating a state of input from input equipment, a state of output to output equipment, and states of an internal relay (auxiliary relay) set on the user program, a timer, a counter, a data memory, and the like. There are two types of device values: a bit type and a word type. The bit device stores a one-bit device value. The word device stores the device value of one word.

The extension unit 4 is prepared for extending the function of the PLC 1. A field device (controlled apparatus) 10 corresponding to the function of the extension unit 4 is connected to each extension unit 4, whereby each field device 16 is connected to the basic unit 3 via the extension unit 4. The field device 10 includes input equipment such as a sensor and output equipment such as an actuator. When it is necessary to identify a plurality of field devices 10, characters a, b, c, . . . are added to the end of reference numerals such as 10a, 10b.

The programming support apparatus 2 is, for example, a portable notebook type or a tablet type personal computer, and includes a display part 7 and an operation part 8. The ladder program which is the example of a user program for controlling the PLC 1 is created using the programming support apparatus 2. The created ladder program is converted into a mnemonic code in the programming support apparatus 2. The programming support apparatus 2 is connected to the basic unit 3 of the PLC 1 via a communication cable 9 such as a universal serial bus (USB) and sends the ladder program converted into the mnemonic code to the basic unit 3. The basic unit 3 converts the ladder program into a machine code and stores the machine code into a memory provided in the basic unit 3. In this case, the mnemonic code is transmitted to the basic unit 3, but the present invention is not limited to this. For example, the programming support apparatus 2 may convert the mnemonic code into an intermediate code and transmit the intermediate code to the basic unit 3.

Although not shown in FIG. 1, a pointing device such as a mouse connected to the programming support apparatus 2 may be included in the operation part 8 of the programming support apparatus 2. The programming support apparatus 2 may be configured to be detachably connected to the basic unit 3 of the PLC 1 via another communication cable 9 other than USB. Further, the programming support apparatus 2 may be configured to be wirelessly connected to the basic unit 3 of the PLC 1 without passing through the communication cable 9.

An IPC 11 is a data collector for collecting time series data from the PLC 1. The IPC 11 may transmit the time series data to a cloud 12. The cloud is an aggregate of server apparatuses that accumulate data and perform predetermined processing on data.

### Ladder Program

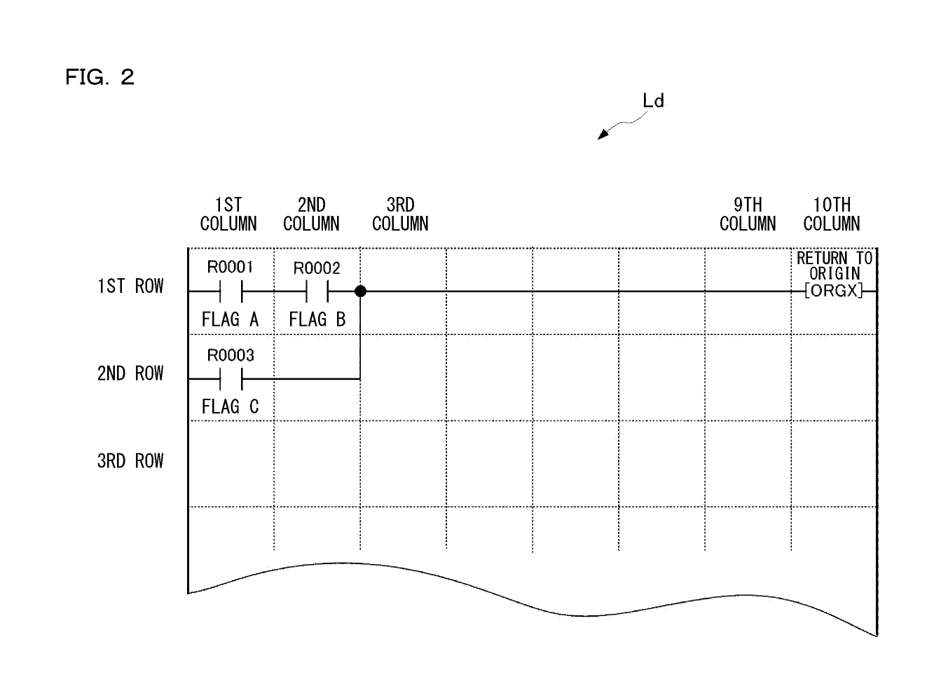

FIG. 2 is a diagram showing an example of a ladder diagram Ld displayed on the display part 7 of the programming support apparatus 2 at the time of creating the ladder program. The programming support apparatus 2 displays a plurality of cells arranged in a matrix on the display part 7. Symbols of virtual devices are arranged in each cell. Symbols indicate input relays, output relays, and the like. A relay circuit is formed by a plurality of symbols. In the ladder diagram Ld, for example, cells of 10 columns×N rows (N is an arbitrary natural number) are arranged. The symbols of the virtual devices are appropriately arranged in the cells of each row.

The relay circuit shown in FIG. 2 includes symbols of three virtual devices (hereinafter referred to as “input devices”) to be turned on and off based on input signals from the input equipment, and a symbol of a virtual device to be turned on and off (hereinafter referred to as “output device”) to control the operation of the output device are appropriately combined with each other.

Characters (“R0001”, “R0002”, and “R0003”) displayed above the symbols of the respective input devices represent device names (address names) of the input devices. Characters (“Flag 1”, “Flag 2”, and “Flag 3”) displayed below the symbols of the respective input devices represent device comments associated with the input devices. Characters (“return to origin”) displayed above the symbol of the output device is a label made up of a character string representing the function of the output device.

In the example shown in FIG. 2, an AND circuit is formed by serially coupling symbols of the two input devices respectively corresponding to the device names “R0001” and “R0002.” In contrast to the AND circuit made up of the symbols of the two input devices, an OR circuit is formed by parallelly coupling symbols of the input device corresponding to the device name “R0003”. That is, in this relay circuit, only when the input devices corresponding to two symbols of the first row are turned on, or only when the input device corresponding to the symbol of the second row is turned on, the output device corresponding to the symbols of the first row is turned on.

### Programming Support Apparatus

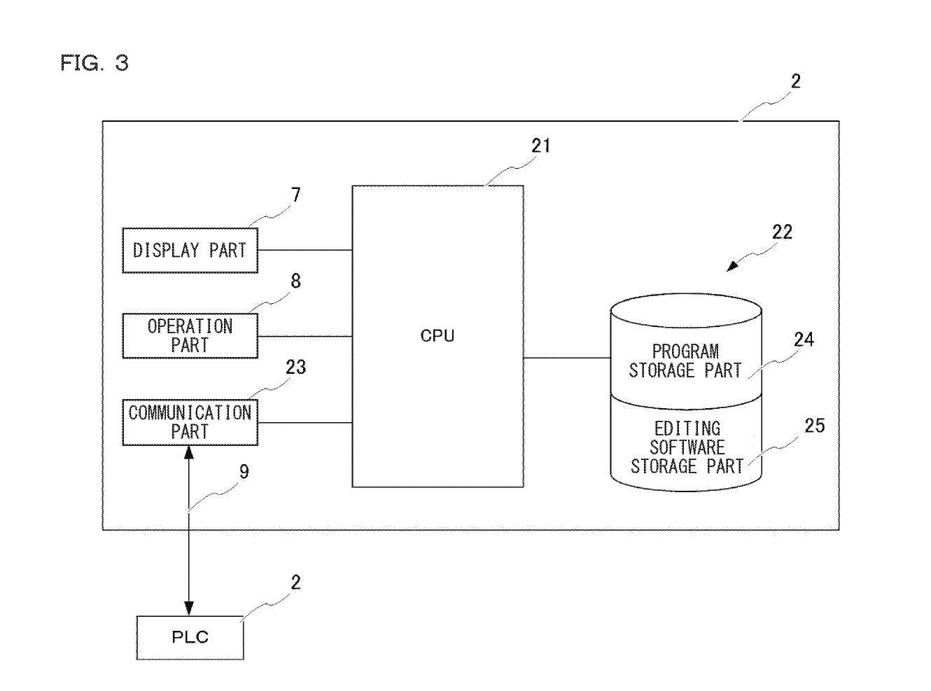

FIG. 3 is a block diagram for explaining an electrical configuration of the programming support apparatus 2. As shown in FIG. 3, the programming support apparatus 2 includes a CPU 21, the display part 7, the operation part 8, a storage 22, and a communication part 23. The display part 7, the operation part 8, the storage 22, and the communication part 23 are electrically connected to the CPU 21. The storage 22 includes at least a RAM, and includes a program storage part 24 and an editing software storage part 25.

The user causes the CPU 21 to execute editing software stored in the editing software storage part 25 and edits the ladder program through the operation part 8. Here, the editing of the ladder program includes creation and modification of the ladder program. The ladder program created using the editing software is stored into the program storage part 24. Further, the user can read the ladder program stored in the program storage part 24 as necessary and change the ladder program by using the editing software. The communication part 23 is for connecting the programming support apparatus 2 to the basic unit 3 in a communicable manner via the communication cable 9.

### PLC

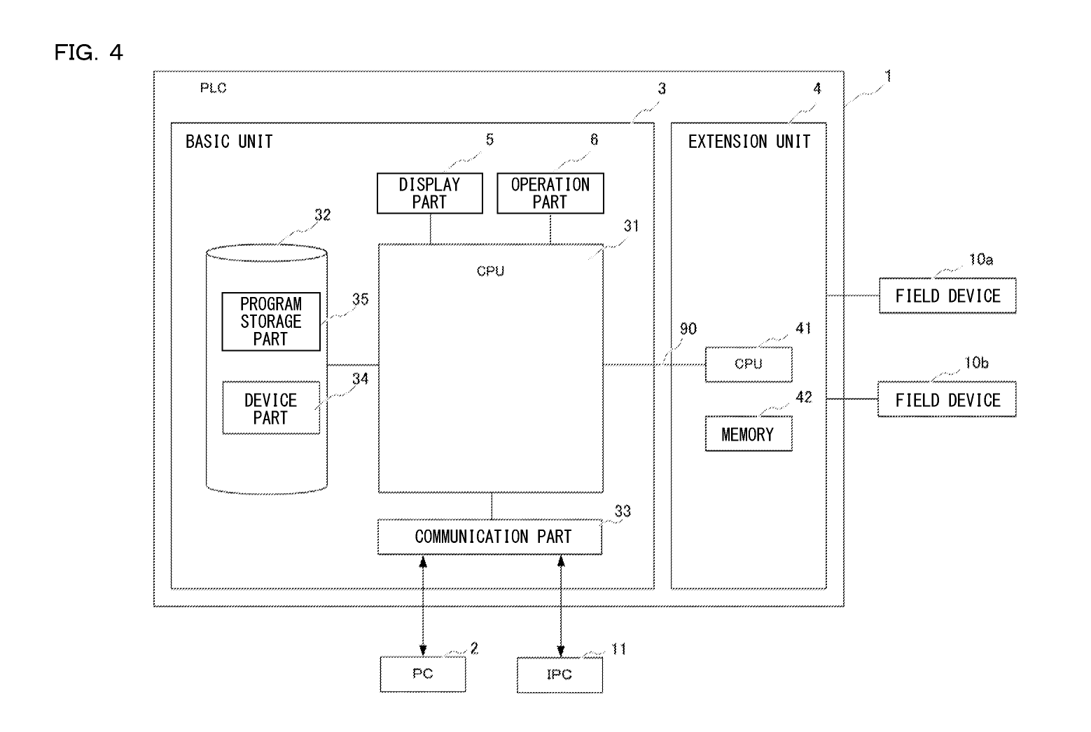

FIG. 4 is a block diagram for explaining the electrical configuration of the PLC 1. As shown in FIG. 4, the basic unit 3 includes a CPU 31, the display part 5, the operation part 6, a storage 32, and a communication part 33. The display part 5, the operation part 6, the storage 32, and the communication part 33 are electrically connected to the CPU 31. The storage 32 may include a RAM, a ROM, a memory card, and the like. The storage 32 has a plurality of storage areas such as a device part 34 and a program storage part 35. The device part 34 includes a bit device, a word device, and the like, and each device stores a device value. The program storage part 35 stores the ladder program and user data, input from the programming support apparatus 2. The program storage part 35 also stores a control program for the basic unit 3. As shown in FIG. 4, the basic unit 3 and the extension unit 4 are connected via a unit external bus 90 which is a type of an extension bus. Note that the communication function relative to the unit external bus 90 may be mounted as a part of the communication part 33.

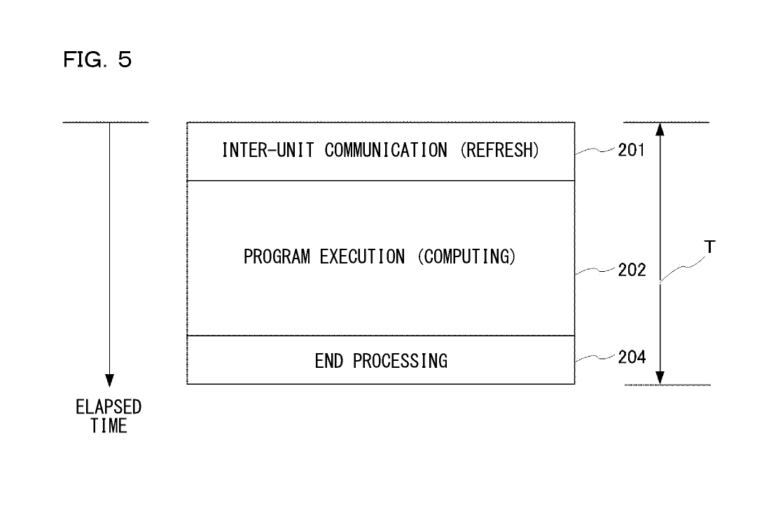

FIG. 5 is a schematic diagram showing the scan time of the basic unit 3. As shown in FIG. 5, one scan time T is made up of inter-unit communication 201, program execution 202, and END processing 204 for performing input/output refresh. In the inter-unit communication 201, the basic unit 3 transmits output data obtained by executing the ladder program from the storage 32 in the basic unit 3 to external equipment such as the extension unit 4. Further, the basic unit 3 captures input data received from the external equipment such as the extension unit 4 into the storage 32 in the basic unit 3. That is, the device value stored in the device of the basic unit 3 is reflected on the device of the extension unit 4 by the output refresh. Similarly, the device value stored in the device of the extension unit 4 is reflected on the device of the basic unit 3 by the input refresh. In this manner, the device of the basic unit 3 and the device of the extension unit 4 are synchronized by the input/output refresh. Note that a mechanism for updating the device values between the units at timing other than the refresh may be adopted. However, the basic unit 3 rewrites the device of the basic unit 3 from time to time, and similarly, the extension unit 4 rewrites the device of the extension unit 4 from time to time. That is, the device of the basic unit 3 can be accessed at any time by the apparatus inside the basic unit 3. Similarly, the device of the extension unit 4 can be accessed at any time by the apparatus inside the extension unit 4. Between the basic unit 3 and the extension unit 4, the device values are basically mutually updated and synchronized at the refresh timing. In the program execution 202, the basic unit 3 executes (computes) the program by using the updated input data. The basic unit 3 performs computing processing on the data by executing the program. Note that the END processing means the whole processing relative to peripheral services such as data communication with external equipment like a display (not shown) connected to the programming support apparatus 2 and the basic unit 3, and error check of the system. The IPC 11 may collect time series data from the PLC 1 in the END processing 204.

In this manner, the programming support apparatus 2 creates a ladder program according to the user's operation, and transfers the created ladder program to the PLC 1. Taking the input/output refresh, the execution of the ladder program, and the END processing as one cycle (one scan), the PLC 1 repeatedly executes this cycle periodically, namely cyclically. Thus, various types of output equipment (motor, etc.) are controlled based on timing signals from various types of input equipment (sensor, etc.). Therefore, the PLC 1 behaves quite differently from a general-purpose personal computer (PC).

### Data Collector

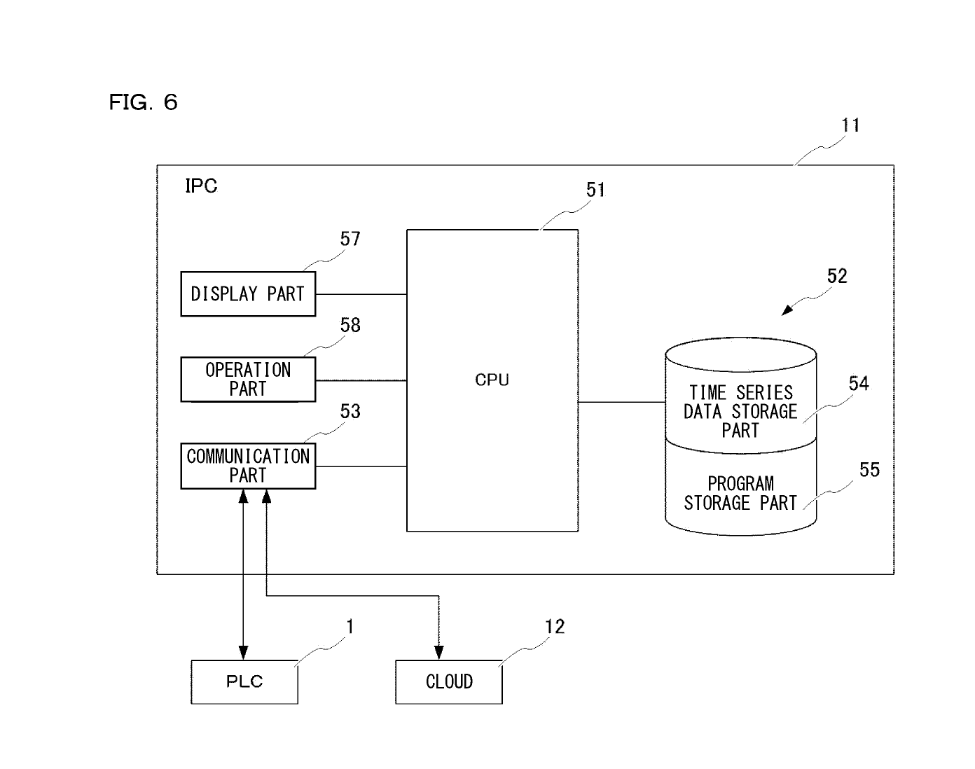

FIG. 6 is a block diagram for explaining the electrical configuration of the IPC 11. The IPC 11 includes a CPU 51, a storage 52, a communication part 53, a display part 57, an operation part 58, and the like. The storage 52, the communication part 53, the display part 57, and the operation part 58 are electrically connected to the CPU 51 via an internal bus or the like. The storage 52 may include a RAM, a ROM, a memory card, a hard disk drive (HDD), a solid state drive (SSD), and the like. The storage 52 is provided with a time series data storage part 54 that stores the time series storage data collected from the PLC 1 and a program storage part 55 that stores the control program executed by the CPU 51. The IPC 11 communicates with the PLC 1 and the cloud 12 via the communication part 53. For example, the CPU 51 collects time series data which is a device value or its aggregate from the PLC 1 via the communication part 53, and stores the time series data into the time series data storage part 54. In addition, the CPU 51 may read the time series data from the time series data storage part 54 and transmit the time series data to the cloud 12 via the communication part 53.

### Cloud

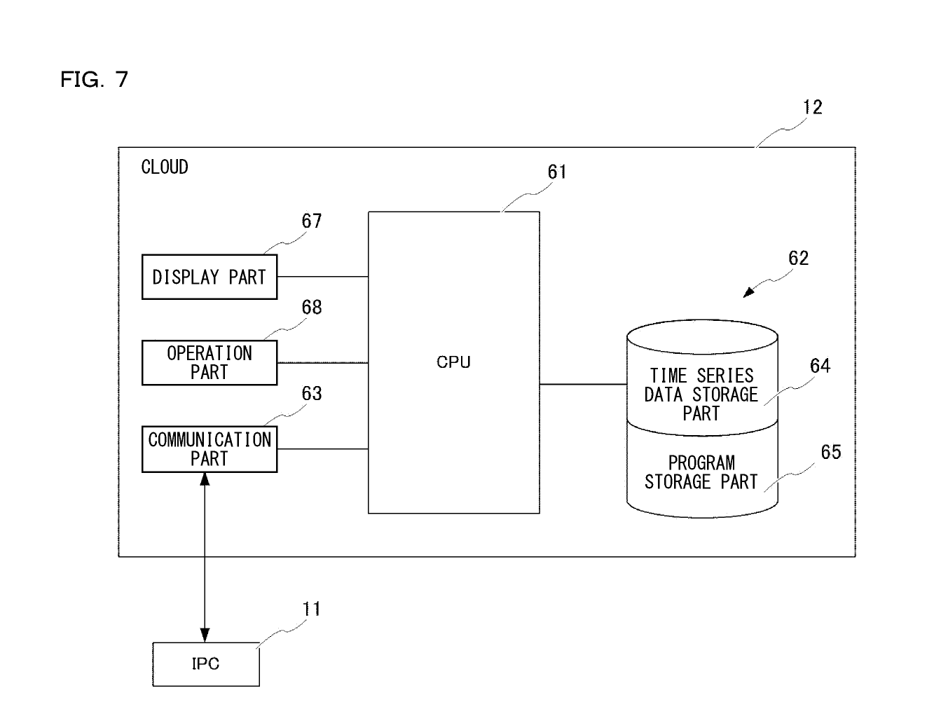

FIG. 7 is a block diagram for explaining the electrical configuration of the cloud 12. The cloud 12 includes a CPU 61, a storage 62, a communication part 63, a display part 67, and an operation part 68. The storage 62, the communication part 63, the display part 67, and the operation part 68 are electrically connected to the CPU 61 via an internal bus or the like. The storage 62 may include a RAM, a ROM, a memory card, a hard disk drive (HDD), a solid state drive (SSD), and the like. The storage 62 is provided with a time series data storage part 64 that stores the time series storage data collected from the PLC 1 via the IPC 11 and a program storage part 65 that stores the control program executed by the CPU 61. The cloud 12 communicates with the PLC 1, the IPC 11, and a client (e.g., programming support apparatus 2) via the communication part 63. For example, the CPU 61 collects time series data from the PLC 1 or the IPC 11 via the communication part 63 and stores the time series data into the time series data storage part 64. In addition, the CPU 61 may perform calculation on the time series data and transmit the time series data to the client via the communication part 63.

### Extraction Period

On a factory line for manufacturing a certain part, the PLC 1 may be used to control the processing of a part or to inspect a part finished. For example, the PLC 1 may apply pressure to a part for cutting in accordance with the user program, or may add heat to the part. Alternatively, the PLC 1 may control an XY stage or the like connected to the extension unit 4 to move the position of the part. In any case, it is necessary to collect and analyze the device values of the PLC 1 in order to investigate the cause when a problem occurs in the processing accuracy of a part or when the problem is likely to occur. Device values change from moment to moment. For example, the device values may change several hundred times in the processing and inspection of one part. This means that several hundred parts of the ladder program are scanned per part. In addition, as the collection period of time series data becomes long, it is not easy for the user to visually confirm and identify which portion of the time series data in the individual data corresponds to which part. Therefore, in the present embodiment, the burden on the user is reduced by the PLC 1, the IPC 11, or the cloud 12 extracting the individual data for each part. The user confirms the individual data through the client such as the programming support apparatus 2.

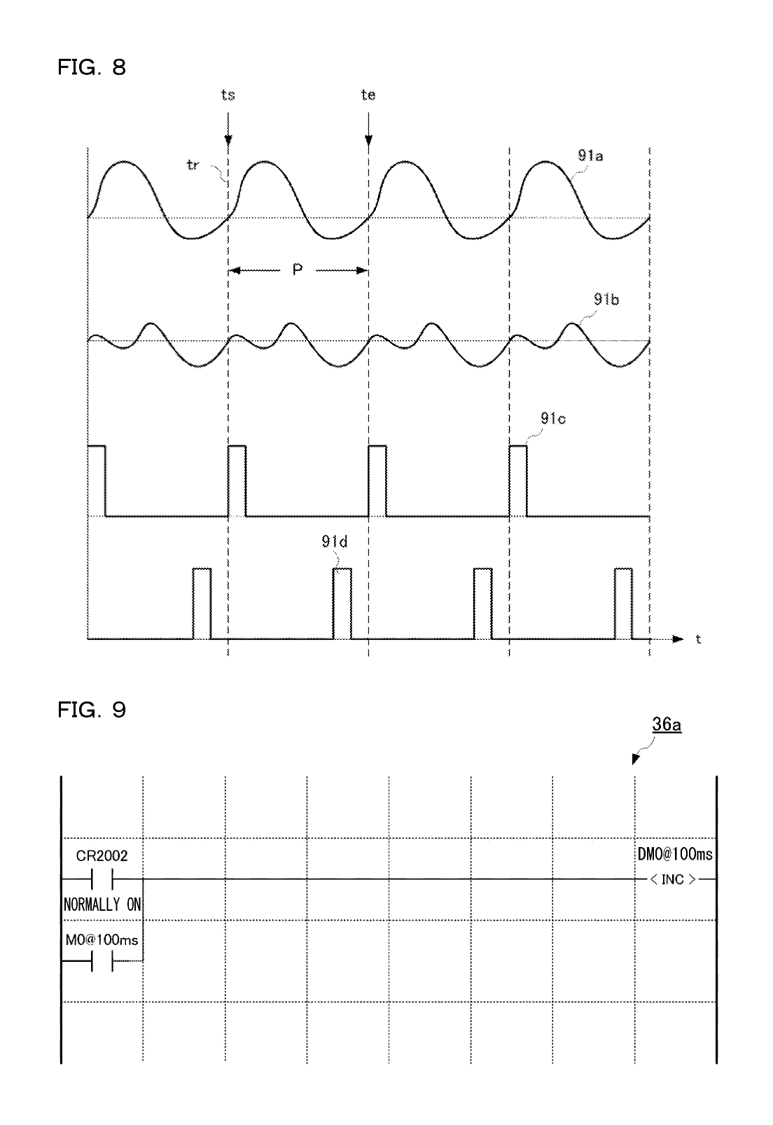

FIG. 8 is a diagram showing time series data of device values. Although four device values 91a to 91d are illustrated here, it is sufficient that at least one device value exists. The extraction period is information indicating the temporal position of the individual data in the time series data. The extraction period is defined by a start position (start time) is and an end position (end time) to of the individual data. The extraction period may be defined by a temporal length P of the extraction period and a reference time tr. The length P may be referred to as a phase period. The reference time tr may be referred to as a reference phase. The length P of the extraction period is the temporal length from the start position ts to the end position te. The reference time tr indicates any position (time) from the start position ts to the end position te. For example, the start position ts may be defined as a time obtained by reducing Δoffset 1 from the reference time tr. The end position te may be defined as a time obtained by adding Δoffset 2 to the reference time tr. Δoffset 1 may be 0 and Δoffset 2 may be P. That is, the end position te may be defined as the time obtained by adding the length P to the start position ts. FIG. 8 shows an example in which the reference time tr coincides with the start position ts. In FIG. 8, the horizontal axis represents time, but may represent the number of times of scanning or the number of times of collecting device values (sampling number). Note that the temporal length of one scan is not necessarily constant.

In FIG. 8, the device value 91a indicates a coordinate change of an X axis of the XY stage, which is a field device. The device value 91b indicates a coordinate change of a Y axis of the XY stage. The device value 91c indicates a request relay. The request relay is a relay in which the basic unit 3 instructs the extension unit 4 to start execution of predetermined processing. The device value 91d indicates a completion relay. The completion relay is a relay in which the extension unit 4 notify the basic unit 3 that the predetermined processing has been completed.

As shown in FIG. 8, individual data for each part has periodicity. This periodicity is caused by the periodicity of repeated processing in the user program. Therefore, the CPU 21 may analyze the user program to specify the periodicity, and the CPUs 21, 31, 51, 61 or the like may extract the individual data in accordance with this periodicity.

Technique of Setting Extraction Period When Editing Ladder Program

FIG. 9 shows a technique of setting an extraction period at the time of editing a ladder program 36a. In this example, a symbol “@” for instructing a period is described after a device name. A numerical value described after this periodic symbol @ indicates a cycle. According to FIG. 9, a device DM0 and a device M0 change at a cycle of 100 ms. The programming support apparatus 2 sets the device in which @ is attached to the device name as a collection target. In addition, the programming support apparatus 2 sets the numerical value described after @ to the length P of the extraction period. In this case, the reference time tr arrives at each instructed cycle. However, the first reference time tr is when the ladder program 36a is activated (at the start of scanning). The second and subsequent reference time tr comes at every 100 ms.

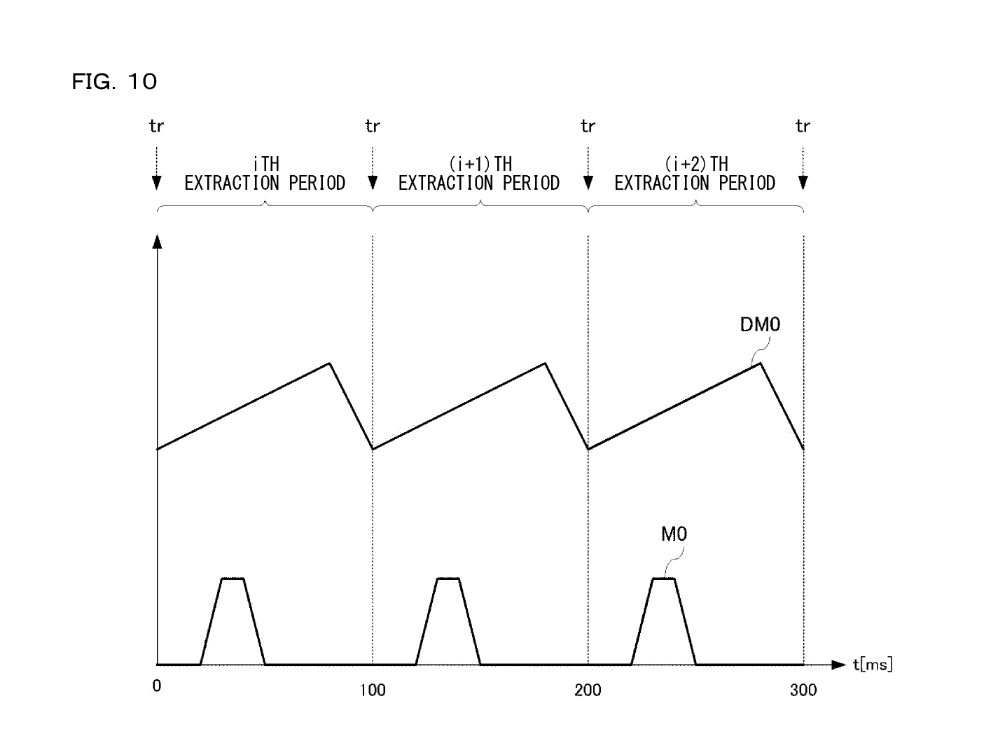

FIG. 10 illustrates a change in the device value stored in the device DM0 and a change in the device value stored in the device M0. As shown in FIG. 10, each of these changes at a set cycle. The PLC 1 extracts the individual data in accordance with the cycle (i.e., extraction period) set by the programming support apparatus 2.

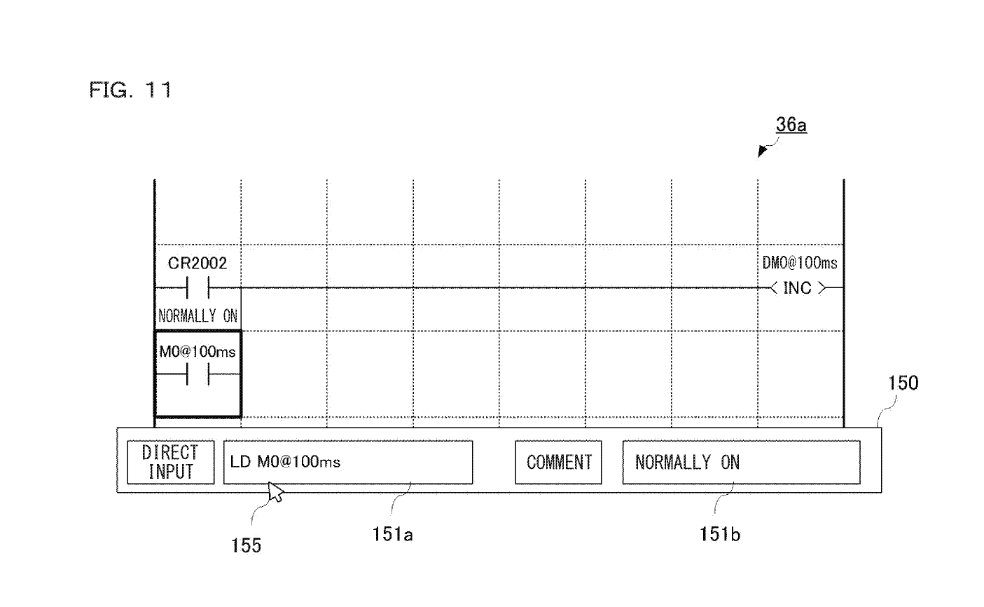

FIG. 11 shows a cycle input technique. The programming support apparatus 2 has a direct input UI 150 for directly inputting an instruction word. When a pointer 155 is operated through the operation part 8 and a cell to be input is selected, the programming support apparatus 2 emphatically displays the selected cell with a thick frame or the like. Further, the programming support apparatus 2 displays the direct input UI 150 on the display part 7. The direct input UI 150 has a text box 151a for directly inputting an instruction word and a text box 151b for inputting a comment.

Another Technique of Setting Extraction Period When Editing Ladder Program

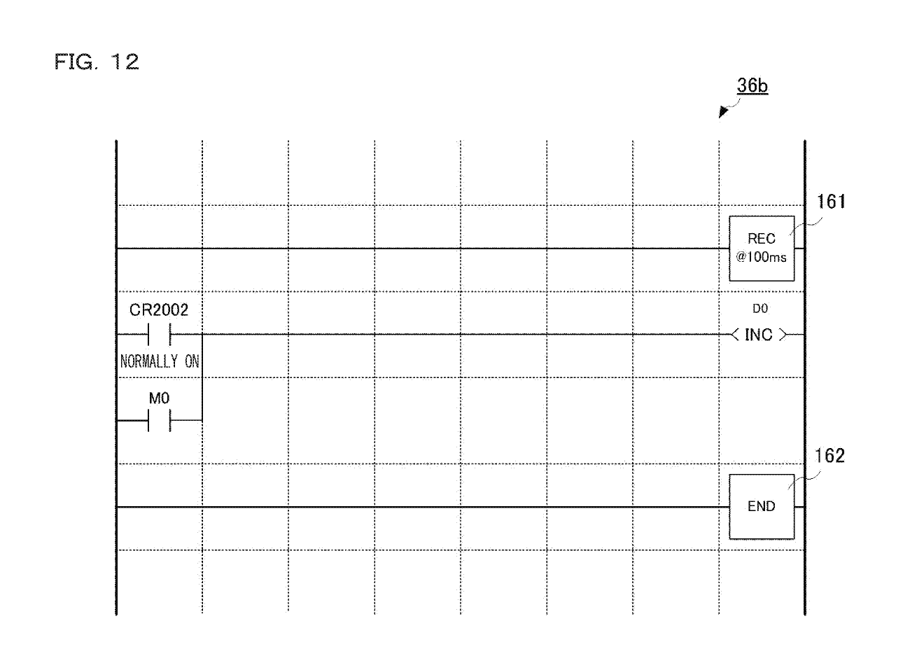

FIG. 12 shows another technique of setting the extraction period when editing a ladder program 36b. In the ladder program 36b, a new instruction word “REC” indicating the collection target and an instruction word “END” are introduced. That is, in the ladder program 36b, a plurality of devices described from REC to END are set as collection targets. Also, “@ 100 ms” indicates that the collection target device changes every 100 ms. Therefore, the programming support apparatus 2 substitutes 100 ms for the length P of the extraction period. The reference time tr comes at every 100 ms. However, the first reference time tr is when the ladder program 36a is activated (at the start of scanning). The second and subsequent reference time tr comes at every 100 ms.

Technique for Setting Extraction Period When Editing Flowchart-Format Motion Program

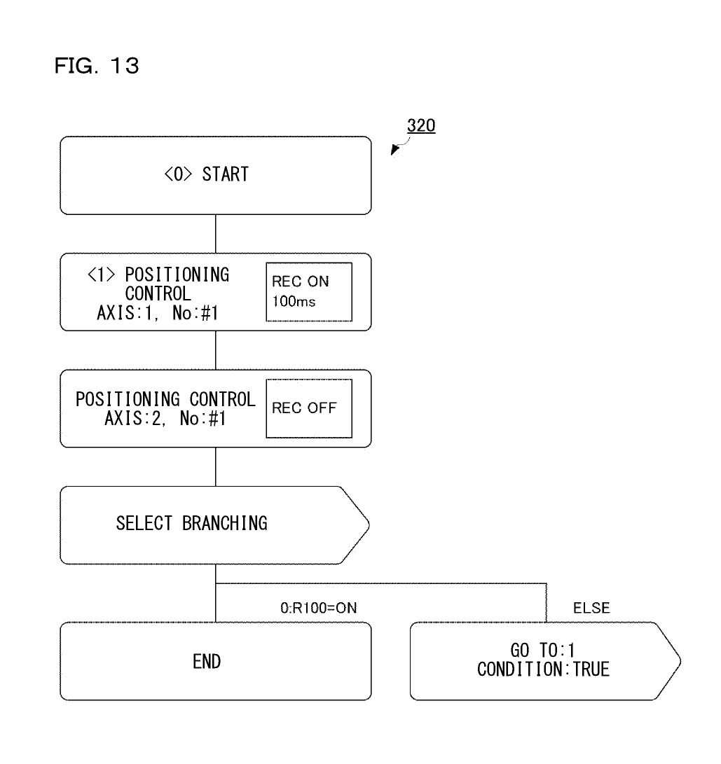

FIG. 13 shows a technique of setting the extraction period when editing a flowchart-format motion program 320. In the flowchart-format motion program, various instruction words for positioning control are described between the start and the end. In FIG. 13, an instruction word for positioning control is extended, and a device described between “REC ON” and “REC OFF” is set as a collection target. Also, the numerical value “100 ms” described together with REC ON indicates that the collection target device changes every 100 ms. Therefore, the programming support apparatus 2 substitutes 100 ms for the length P of the extraction period. The reference time tr comes at every 100 ms. However, the first reference time tr is when the ladder program 36a is activated (at the start of scanning). The second and subsequent reference time tr comes at every 100 ms.

Others

The above description technique is only an example. For example, that the collection target device is M0, the start position of the extraction period is a rising edge (change from OFF to ON) of the relay device R100, and the end position of the extraction period is a trailing edge (change from ON to OFF) of the relay device R100 (may be described as M0@R100. That the collection target device is M0, the reference time tr of the extraction period is a rising edge (change from OFF to ON) of the relay device R100, and the extraction period is 5 ms before and after the reference time tr may be described as M0@R100/5 ms. In this case, the length P of the extraction period is 10 ms.

### <Function Block

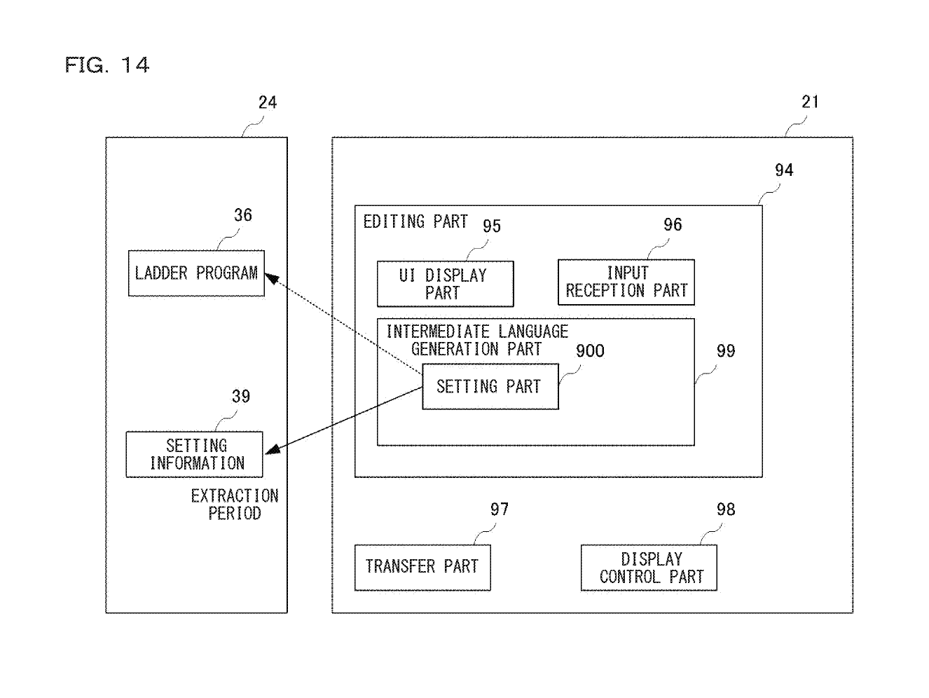

FIG. 14 is a block diagram for explaining functions relative to the setting of the extraction period. Here, the programming support apparatus 2 analyzes the user program to set or decide the extraction period. By executing the editing software stored in the editing software storage part 25, the CPU 21 achieves an editing part 94, a transfer part 97, a display control part 98, an intermediate language generation part 99, and the like. A UI display part 95 of the editing part 94 causes the display part 7 to display a user interface (UI) for assisting input of the user program. The UI display part 95 causes the display part 7 to display the UI as shown in FIGS. 9 to 13. An input reception part 96 receives an input of the user program by the user through the user interface. The user inputs the user program by operating the operation part 8. That is, the input reception part 96 receives an instruction from the user that is input via the operation part 8. The UI display part 95 reflects the user input on the user interface. The intermediate language generation part 99 is a compiler that converts a source program, such as a ladder diagram or a flowchart-format motion program, into intermediate language. As described with reference to FIGS. 9 to 13, the user describes an instruction word for setting the extraction period in the user program. Therefore, a setting part 900 in the intermediate language generation part 99 finds a specific instruction word (e.g., @, REC, END, REC ON, etc.) relative to the extraction period described in the user program, and creates information indicating the collection target device and information indicating the extraction period in accordance with the instruction word. The setting part 900 may embed the information indicating the collection target device and the information indicating the extraction period into the intermediate language (intermediate code) of the user program, or may write the information into setting information 39 separated from the user program. The setting information 39 is information to be transferred to the PLC 1 and the like together with the user program. The transfer part 97 transfers a user program such as the ladder program 36 to the PLC 1 and transfers the setting information 39 to the PLC 1, the IPC 11, and the cloud 12. The display control part 98 causes the display part 7 to display the individual data transmitted from the PLC 1, the IPC 11, and the cloud 12.

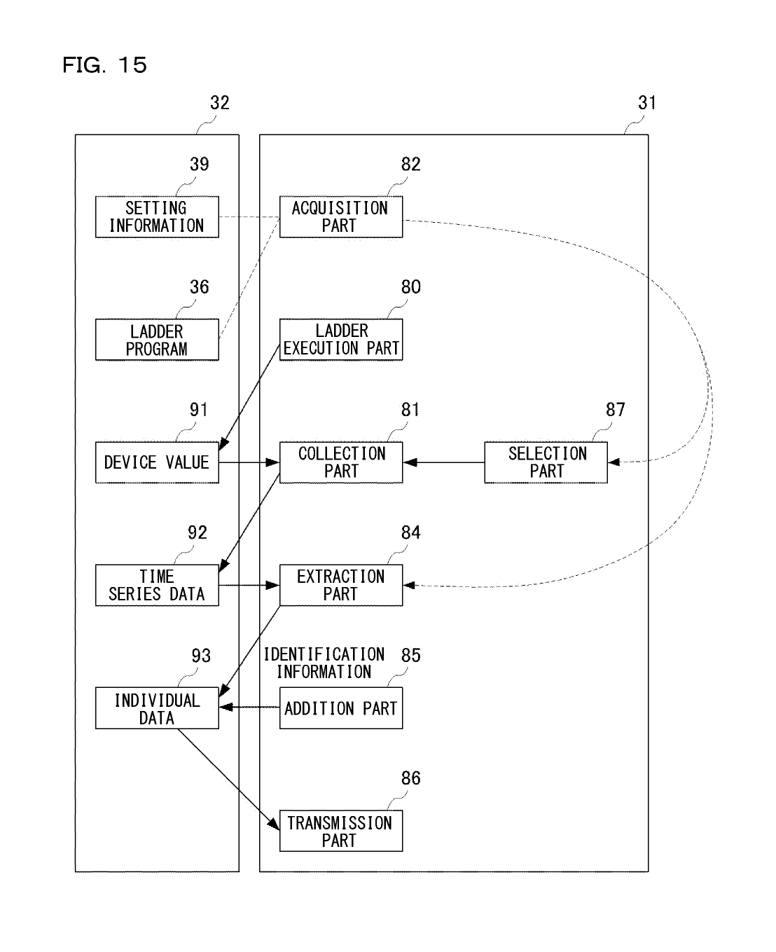

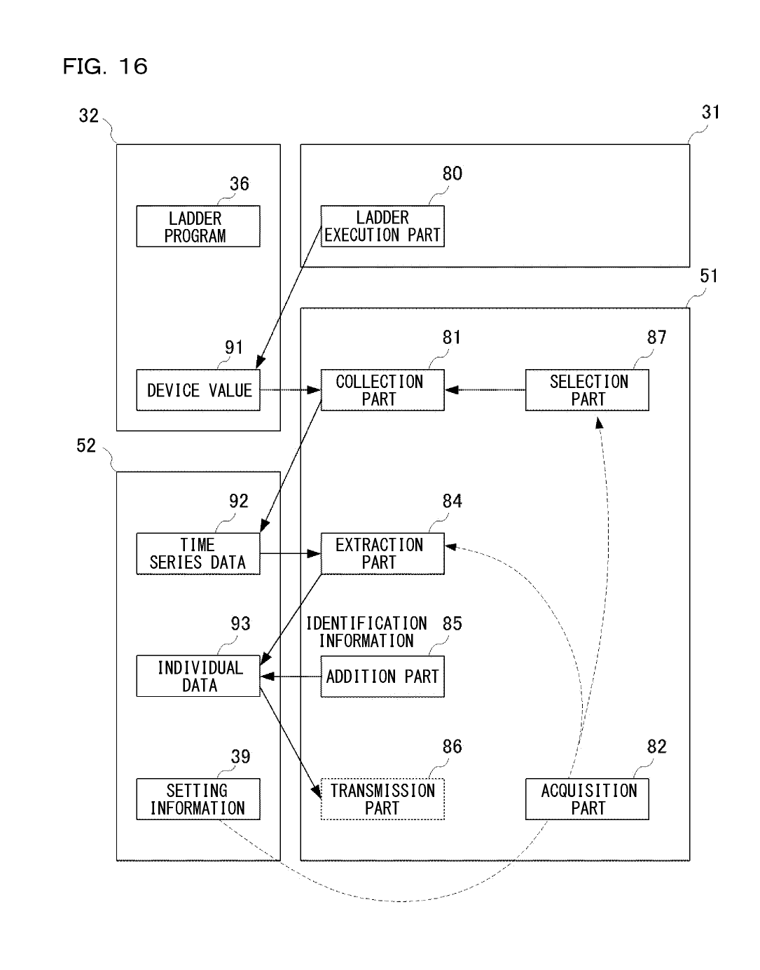

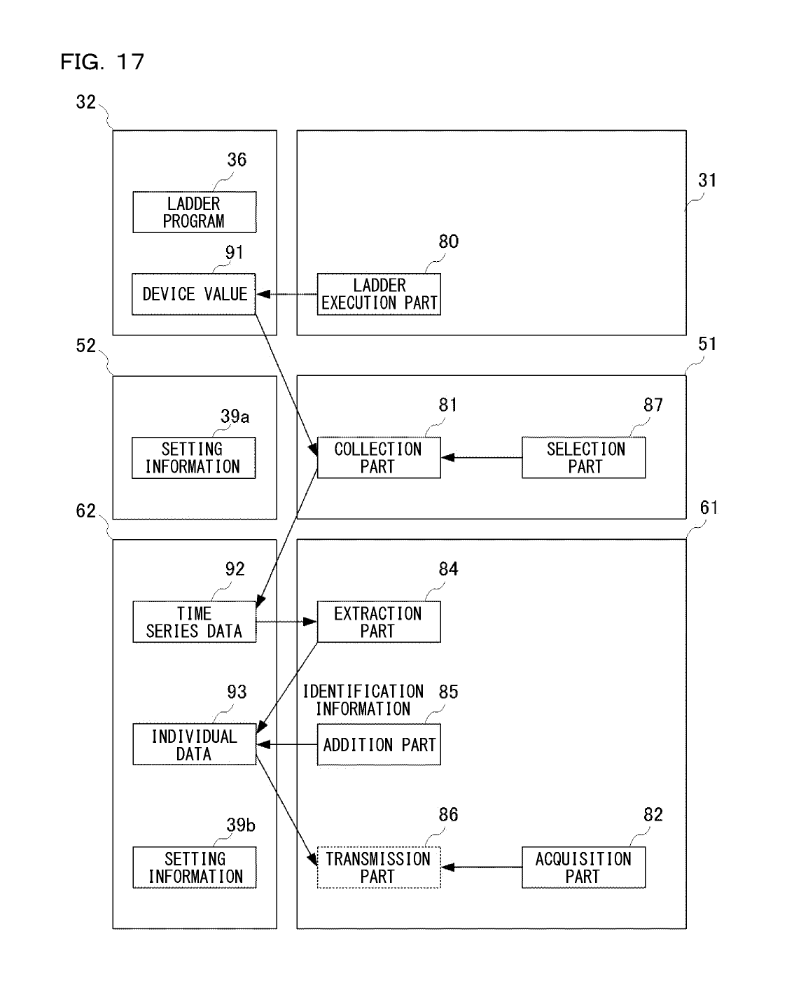

FIG. 15 is a diagram for explaining the functions relative to the individual data extraction processing. Here, functions relative to collection of time series data and extraction of individual data are mounted in the PLC 1. However, as shown in FIGS. 16 and 17, these functions may be mounted in the IPC 11 or mounted in the cloud 12.

In FIG. 15, the CPU 31 of the basic unit 3 achieves the following functions by executing the control program stored in the storage 32. A ladder execution part 80 is a program execution part that executes the user program and performs computing processing on information stored in a plurality of devices in accordance with the user program. Here, the ladder program 36 is used as an example of the user program. When the user program is a flowchart-format motion program such as a sequential function chart (SFC), the ladder execution part 80 functions as an execution part that executes a flowchart-format motion program. The ladder execution part 80 executes the ladder program 36 stored in the storage 32 and updates a device value 91 for each scan. A collection part 81 is a data collection part that forms time series device data (time series data 92) by repeatedly collecting device data (device values 91) stored in at least one device.

An acquisition part 82 acquires information indicating the extraction period from the setting information 39. Alternatively, the acquisition part 82 may decide the extraction period and the collection target device by analyzing the user program such as the ladder program 36 or the flowchart-format motion program, or analyzing the intermediate code thereof. In this case, the acquisition part 82 will execute the same processing as the setting part 900.

A selection part 87 selects the device value collected by the collection part 81. For example, the selection part 87 may select the collection target device instructed by the setting information 39. Alternatively, the selection part 87 may analyze the user program instead of the acquisition part 82 and select the collection target device. Incidentally, the user may divide a plurality of devices into several groups in the programming support apparatus 2 and add a logging target ID to each group. The user selects a group by selecting the logging target ID in the programming support apparatus 2. The ID of the selected group, that is, the logging target ID, is stored into the setting information 39 and transferred to the PLC 1 together with the user program. Therefore, the selection part 87 acquires the logging target ID stored in the setting information 39, further acquires one or more devices associated with the logging target ID, and sets identification information of the acquired device in the collection part 81. The collection part 81 collects device values from the set device. The user may select one or more devices for chart-format monitor or debugging in real time in the programming support apparatus 2, store the identification information of the selected device into the setting information 39, and transfer the identification information to the PLC 1 together with the user program. The selection part 87 may set in the collection part 81 the identification information of the device stored in the setting information 39. The chart-format monitor in real time is a function that the programming support apparatus 2 reads the device value from the PLC 1 at high speed and displays the time series device value on the display part 7 in real time in a chart form (graph form). Debugging is debugging of the user program. The identification information of the debugging device is also stored into the setting information 39 and transferred to the PLC 1 together with the user program. The programming support apparatus 2 acquires the device value of the debugging device from the PLC 1 and displays the device value on the display part 7. In this way, a real-time chart-format monitor and a debugging device may be selected for extracting the individual data 93. One or more device values may be displayed on the display part 5 of the PLC 1 in addition to the display part 7 of the programming support apparatus 2. Also in this case, the identification information of the acquisition target device is stored into the setting information 39 and transferred to the PLC 1 together with the user program. Therefore, the selection part 87 may select the device value to be acquired by the collection part 81 by analyzing the setting information 39. The selection part 87 may be provided inside the collection part 81.

An extraction part 84 extracts from the time series data 92 the individual data 93 in each extraction period, instructed by the information indicating the extraction period acquired from the setting information 39 by the acquisition part 82. Alternatively, the extraction part 84 extracts from the time series data 92 the individual data 93 in the extraction period acquired by analyzing the user program or the intermediate code by the acquisition part 82.

An addition part 85 adds identification information for identifying individual data to each piece of the individual data extracted by the extraction part 84. The identification information may be a serial number, for example, but may be other information as long as each piece of individual data is distinguishable. A transmission part 86 is optional and transmits the individual data 93 to the programming support apparatus 2 which is a client. When the user considers the individual data 93 in the PLC 1, the CPU 31 may cause the display part 5 to display the individual data 93. The display part 5 may be an external display apparatus connected to the PLC 1. The format of the individual data 93 may be CSV format or SQL format. SQL is a type of database language.

FIG. 16 shows an example in which the IPC 11 has a device value collection function and an extraction function. The functions already described are omitted or described briefly. The CPU 51 of the IPC 11 achieves various functions by executing the control program stored in the program storage part 55. As shown in FIG. 16, the collection part 81, the acquisition part 82, the extraction part 84, the addition part 85, the transmission part 86, the selection part 87, and the like are mounted. The acquisition part 82 acquires information indicating the extraction period from the setting information 39 and sets the extraction period in the extraction part 84. The acquisition part 82 acquires information indicating the collection target device from the setting information 39 and transfers this information to the selection part 87. The selection part 87 sets in the collection part 81 the acquisition target device based on the setting information 39. The selection part 87 may be integrated into the acquisition part 82. The collection part 81 collects device values from the acquisition target device instructed by the setting information 39. For example, when the acquisition condition (e.g., periodic) is satisfied, the collection part 81 acquires the device value 91 from the PLC 1 and stores the device value 91 into the time series data storage part 54 of the storage 52. The extraction part 84 extracts the individual data 93 for each part in accordance with the extraction period instructed by the setting information 39. The addition part 85 adds identification information to the extracted individual data 93. The transmission part 86 is optional and transmits the individual data 93 to the cloud 12 and the programming support apparatus 2. When consideration of the individual data 93 is executed in the IPC 11, the CPU 51 causes the display part 57 to display the individual data 93. When the IPC 11 is omitted, these functions are achieved by the CPU 61 of the cloud 12, the storage 62, the display part 67, and the like.

FIG. 17 shows an example in which the IPC 11 has a device value collection function and the cloud 12 has an extraction function. The collection part 81 of the IPC 11 collects device values from the device instructed by the setting information 39a, creates the time series data 92, and transmits the time series data 92 to the cloud 12. The selection part 87 functions as the above-described acquisition part 82, acquires information indicating the collection target device from the setting information 39a, and sets it in the collection part 81.

The CPU 61 of the cloud 12 executes the control program stored in the program storage part 65 to achieve the extraction part 84, the addition part 85, and the like. The CPU 61 of the cloud 12 stores the time series data 92 received from the IPC 11 into the time series data storage part 64. The acquisition part 82 acquires information indicating the extraction period from the setting information 39b and sets the information in the extraction part 84. The extraction part 84 extracts the individual data 93 for each part in accordance with the extraction period instructed by the setting information 39b. The addition part 85 adds identification information to the extracted individual data 93. Further, the CPU 61 causes the display part 67 to display the individual data 93. Alternatively, in order to display the individual data 93 on the display part 7 of the programming support apparatus 2, the transmission part 86 may transmit the individual data 93 to the programming support apparatus 2.

### Flowchart

Decision Processing of Extraction Period

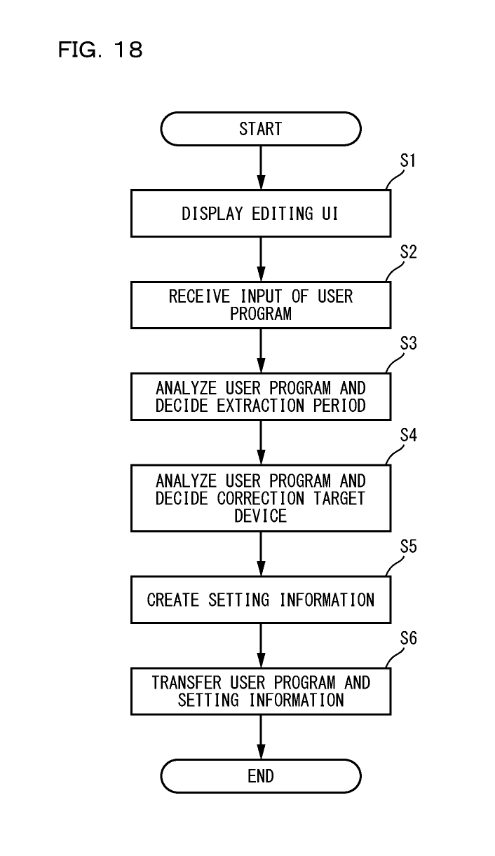

FIG. 18 shows extraction period setting processing executed by the CPU 21 of the programming support apparatus 2. The CPU 21 executes the following steps in accordance with the editing software.

In S1, the CPU 21 (UI display part 95) causes the display part 7 to display an editing UI for editing the user program such as the ladder program 36.

In S2, the CPU 21 (input reception part 96) receives the input of the user program via the operation part 8. The user describes into the user program an instruction word instructing an extraction period and a collection target device by using any of the above described techniques.

In S3, the CPU 21 (setting part 900) analyzes the user program and decides the extraction period. For example, the setting part 900 finds the extraction period described by using any of the techniques described with reference to FIGS. 9 to 13.

In S4, the CPU 21 (setting part 900) analyzes the user program and the user setting to decide the collection target device. For example, the setting part 900 finds a collection target device described by using any of the techniques described with reference to FIGS. 9 to 13. Note that the setting part 900 may select a logging target device or a device instructed for debugging as a collection target.

In S5, the CPU 21 (setting part 900) creates the setting information 39 that includes information indicating the extraction period and information indicating the collection target device.

In S6, the CPU 21 (transfer part 97) transfers the user program such as the ladder program 36 and the setting information 39 to the PLC 1 and the like.

When the PLC 1 analyzes the user program and decides the extraction period, S3 and the like are omitted. When the PLC 1 analyzes the user program and decides the collection target device, S4 and the like are omitted.

Collection Processing

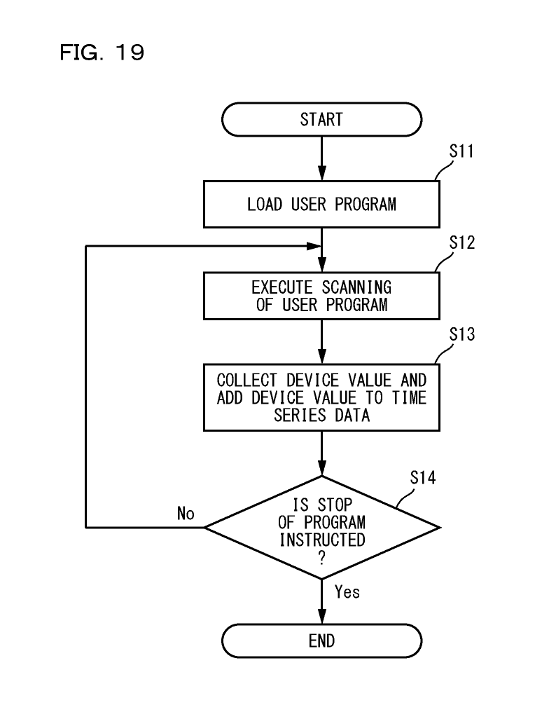

FIG. 19 is a flowchart showing collection processing executed by the CPU 31 of the PLC 1. The operation part 6 is provided with a switch for switching between a setting mode and an operation mode. The setting mode is processing for receiving a user program and project data from the programming support apparatus 2. The operation mode is a mode for executing the user program. When switching from the setting mode to the operation mode is instructed, the CPU 31 executes the following processing.

In S11, the CPU 31 (ladder execution part 80) loads the user program into the RAM. When the PLC 1 analyzes the user program and the intermediate code to decide the extraction period and the collection target device, this decision is executed by the CPU 31 (acquisition part 82) between S11 and S12.

In S12, the CPU 31 (ladder execution part 80) executes scanning of the user program. The ladder execution part 80 executes predetermined computing on device values stored in the various devices in accordance with the user program and updates the device values. The contents of the predetermined calculation are defined by the user program.

In S13, the CPU 31 (collection part 81) collects device values. The collection part 81 reads the device value from the acquisition target device selected by the selection part 87 and adds the device value to the time series data 92. As described above, the collection processing may be executed by the CPU 51 of the IPC 11 or may be executed by the CPU 61 of the cloud 12. The collection timing (sampling timing) of the device value may be for each scan or every several scans. The collection may be performed in the end processing or during the scan. Further, the collection may be performed a plurality of times in one scan. The collection timing may also be instructed by the setting information 39.

In S14, the CPU 31 (ladder execution part 80) determines whether or not the stop of the program is instructed. For example, when the switch described above is switched from the operation mode to the setting mode, the CPU 31 determines that the stop of the program has been instructed. When the stop of the program has not been instructed, the CPU 31 repeatedly executes the processing of S12 to S14. When the stop of the program is instructed, the CPU 31 stops the user program. In this way, the time series data 92 is collected.

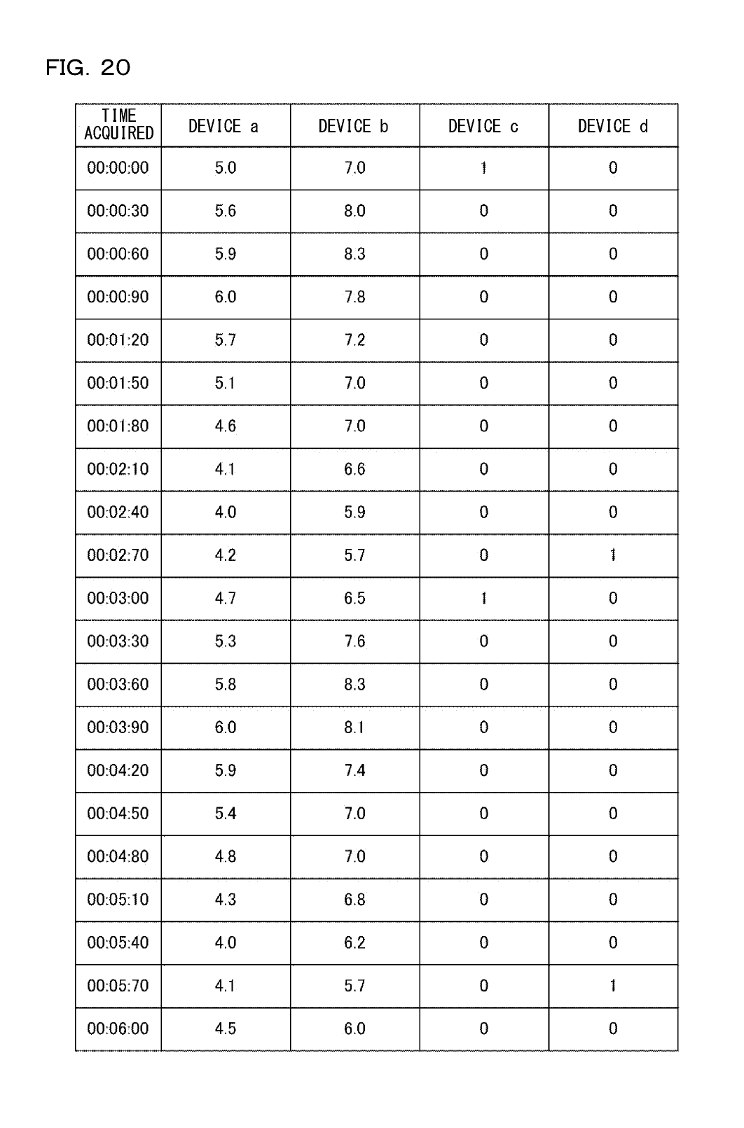

FIG. 20 shows an example of the time series data 92. Time information is indicated by “minute: second: 1/100 second”. Here, devices a, b, c, d have been selected as acquisition targets by the selection part 87. The devices a, b store one word of data such as the X and Y coordinates of the XY stage. The device c is a bit device, here being a request relay. The device d is a bit device, here being a completion relay. As shown in FIG. 20, at this stage, it is difficult for the user to specify which part of time series data 92 corresponds to which part.

Extraction Processing

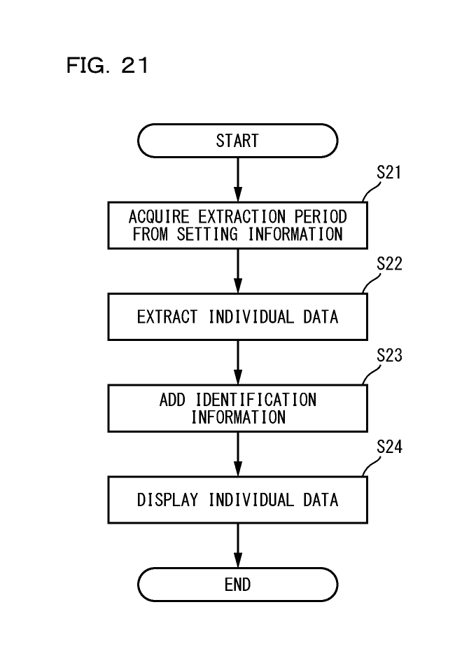

FIG. 21 is a flowchart showing extraction processing of individual data. As described above, the extraction processing may be executed by any one of the CPUs 21, 31, 51, 61, but it is assumed here that the extraction processing is executed by the CPU 31.

In S21, the CPU 31 (acquisition part 82) acquires information indicating the extraction period of the individual data from the setting information 39. The acquisition part 82 may acquire information indicating the extraction period by analyzing the user program and its intermediate code. The acquisition part 82 sets the extraction period in the extraction part 84.

In S22, the CPU 31 (extraction part 84) extracts from the time series data 92 the individual data 93 for each part in accordance with the information indicating the extraction period.

In S23, the CPU 31 (addition part 85) adds the identification information to each piece of individual data 93 extracted by the extraction part 84.

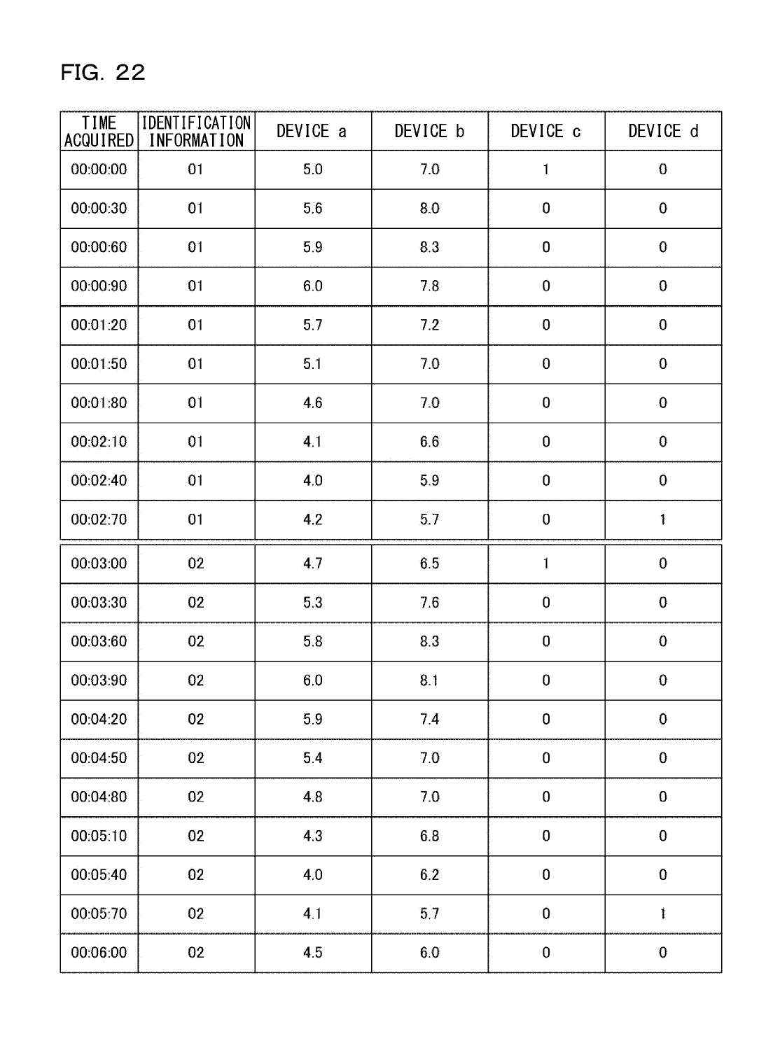

FIG. 22 shows an example of the individual data 93. The extraction part 84 cuts the individual data 93 for each part out of the time series data 92 and adds the identification information to each piece of individual data 93. In FIG. 22, two pieces of individual data 93 are exemplified, and “01” and “02” are added as different identification information. Hence, the user can easily distinguish the individual data 93 for each part.

In S24, the CPU 31 causes the display part 5 to display the individual data 93. As described above, the CPU 31 may transmit the individual data 93 to the programming support apparatus 2 so as to cause the display part 7 of the programming support apparatus 2 to display the individual data 93. Note that S23 and S24 may be synchronous execution or asynchronous execution. That is, for example, the CPU 31 may shift to the processing to S24 based on the display instruction of the user. In this case, for example, the CPU 31 may repeatedly execute the processing of S22 and S23 until the display instruction of the user is made via the operation part 8, and when the display instruction of the user is made, the CPU 31 may shift to the processing to S24.

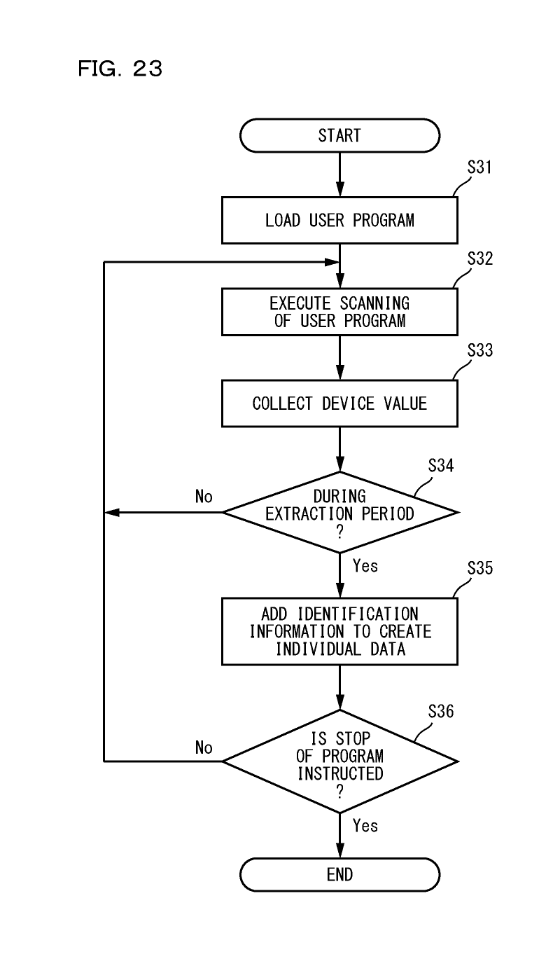

According to FIGS. 19 and 21, the processing of collecting the time series data 92 and the processing of extracting the individual data 93 are separated for the sake of convenience. However, the collection processing and the extraction processing may be integrated. FIG. 23 shows processing in which the collection processing and the extraction processing are integrated. Before S31 or between S31 and S32, the acquisition part 82 acquires information indicating the extraction period and information indicating the collection target device from the setting information 39 or the user program.

In S31, the CPU 31 (ladder execution part 80) loads the user program into the RAM.

When the PLC 1 analyzes the user program and the intermediate code to decide the extraction period and the collection target device, this decision is executed by the CPU 31 (acquisition part 82) between S31 and S32.

In S32, the CPU 31 (ladder execution part 80) executes scanning of the user program. The ladder execution part 80 executes predetermined computing on device values stored in the various devices in accordance with the user program and updates the device values. The contents of the predetermined calculation are defined by the user program.

In S33, the CPU 31 (collection part 81) collects device values. The collection part 81 reads the device value from the acquisition target device selected by the selection part 87.

In S34, the CPU 31 (extraction part 84) determines whether or not the timing at which the collection part 81 collects the device values is during the extraction period instructed by the setting information 39 or the user program. For example, it is assumed that M0@R100 has been described in the user program, and the period during which the relay device R100 is on has been instructed as the extraction period. In this case, the extraction part 84 reads the device value of the relay device R100 instructed by the user program, and determines whether or not the device value is on. When the device value of the relay device R100 is on, the extraction part 84 determines that the extraction period is in progress and proceeds the processing to S35. On the other hand, when the device value of the relay device R100 is not on, the extraction part 84 determines that the extraction period is not in progress and proceeds the processing to S32.

In S35, the CPU 31 (addition part 85) creates the individual data 93 by adding the identification information to the device values collected during the extraction period.

In S36, the CPU 31 (ladder execution part 80) determines whether or not the stop of the program has been instructed. When the stop of the program has not instructed, the CPU 31 repeatedly executes the processing of S32 to S36. When the stop of the program is instructed, the CPU 31 stops the user program. In this way, a series of individual data 93 is collected.

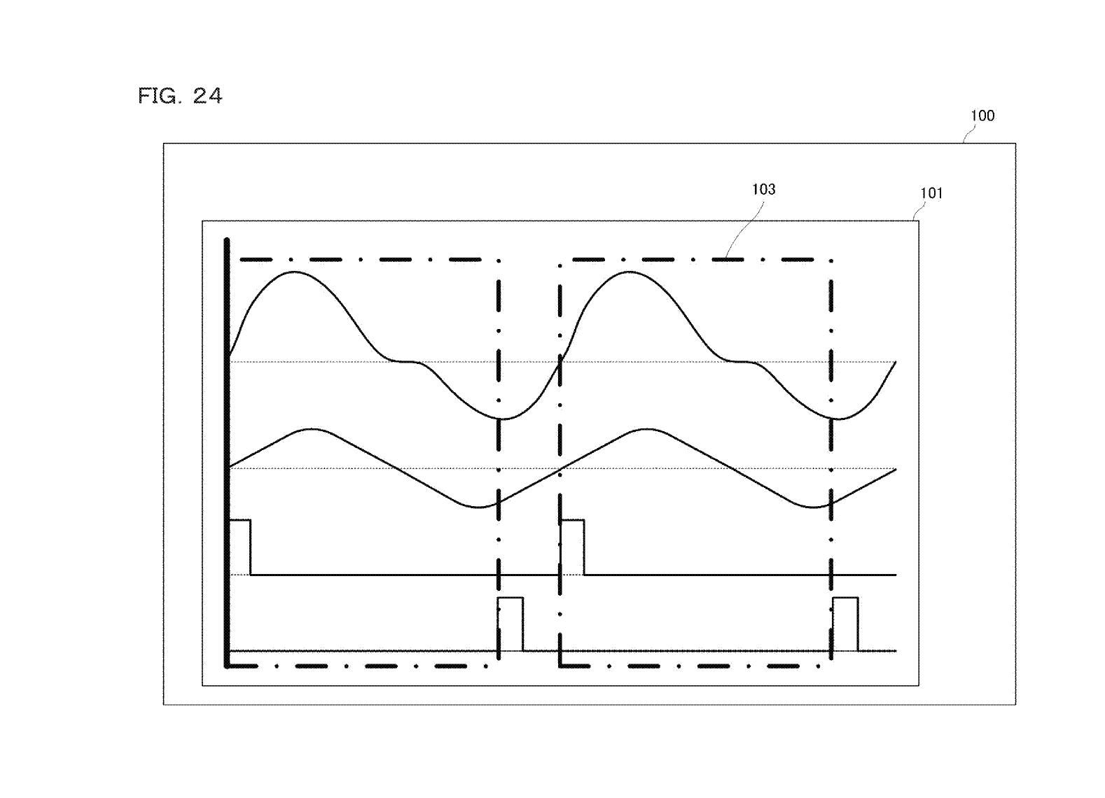

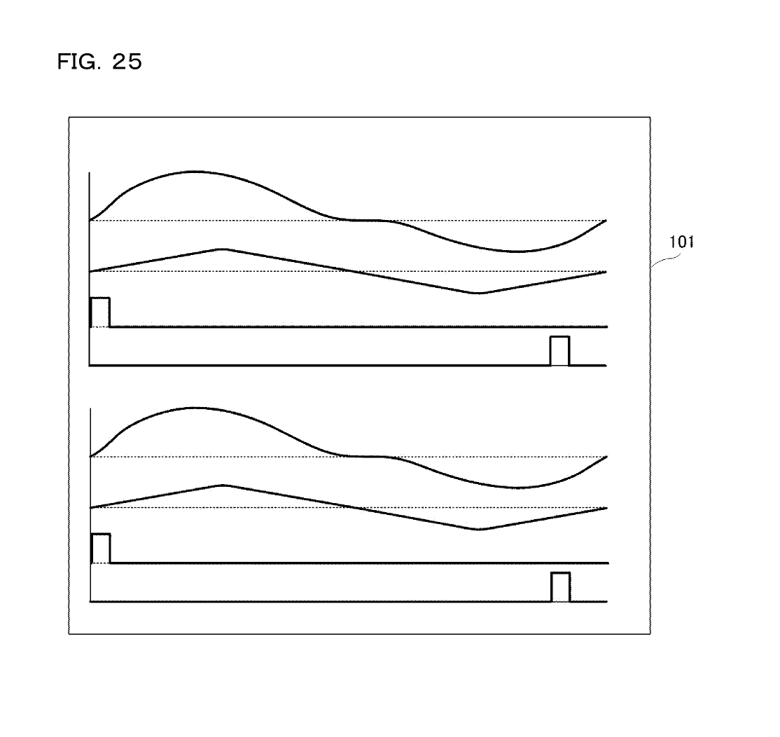

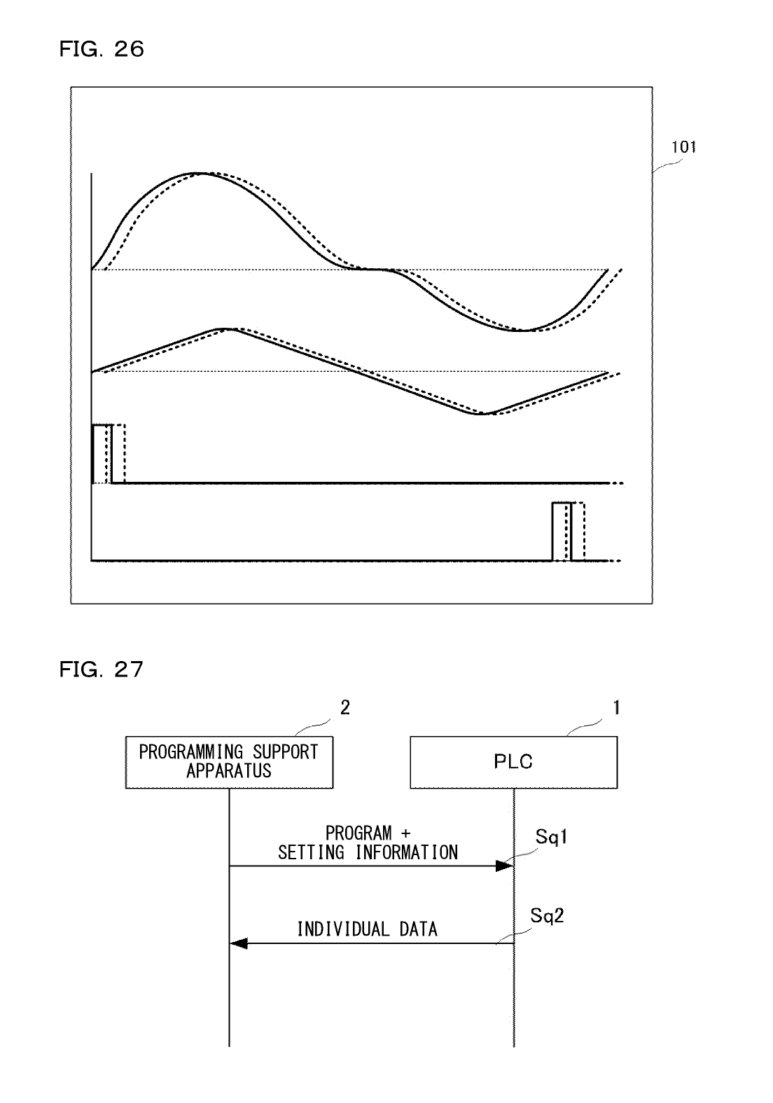

FIG. 24 shows an example of the user interface (UI 100) for displaying the individual data 93. An individual data display part 101 is a display area for displaying the individual data 93. In this example, two pieces of individual data 93 are displayed. A frame 103 is a UI indicating the extraction period. FIG. 25 shows another example of the individual data display part 101. In this example, two pieces of individual data 93 are vertically aligned and displayed. FIG. 26 shows another example of the individual data display part 101. In this example, two pieces of individual data 93 are overlapped and displayed. For example, the CPU 21 (display control part 98) may overlap the two pieces of individual data 93 so that the extraction periods of the two pieces of individual data 93 overlap. The display control part 98 may position one piece of the individual data 93 and the other piece of the individual data 93 so that the number of overlapping portions of the two pieces of individual data 93 increases. In particular, by overlapping and displaying the two pieces of the individual data 93, the user will be able to visually find a subtle difference between the two pieces of individual data 93 easily.

### Sequence

FIG. 27 shows a sequence relative to transmission and reception of the individual data 93. In this example, the collection part 81, the acquisition part 82, the selection part 87, the addition part 85, and the transmission part 86 are mounted on the CPU 31 of the PLC 1. The editing part 94, the setting part 900, the transfer part 97, and the display control part 98 are mounted on the CPU 21 of the programming support apparatus 2.

In Sq 1, the programming support apparatus 2 transmits the user program and the setting information 39, and the PLC 1 receives these and stores these into the storage 32.

In Sq 2, the PLC 1 obtains a device value in accordance with the user program and collects the time series data 92 in accordance with the setting information 39. The PLC 1 extracts the individual data 93 in accordance with the setting information 39 and transmits the setting information 39 to the programming support apparatus 2. The programming support apparatus 2 displays the individual data 93 on the display part 7.

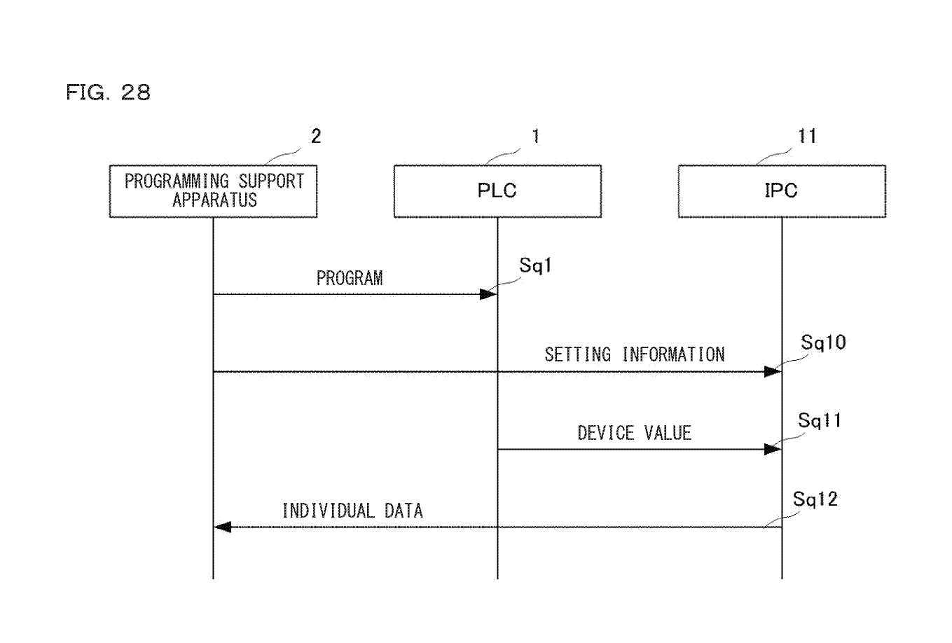

FIG. 28 shows another a sequence relative to transmission and reception of the individual data 93. In this example, the collection part 81, the acquisition part 82, the selection part 87, the extraction part 84, the addition part 85, and the transmission part 86 are mounted on the CPU 51 of the IPC 11.

In Sq 1, the programming support apparatus 2 transmits the user program, and the PLC 1 receives this and stores this into the storage 32.

In Sq 10, the programming support apparatus 2 transmits the setting information 39 to the IPC 11, and the IPC 11 receives this and stores this into the storage 52.

In Sq 11, the PLC 1 obtains a device value in accordance with the user program. The IPC 11 reads (receives) the device value from the PLC 1 in accordance with the setting information 39.

In Sq 12, the IPC 11 creates the time series data 92 from the collected device values. The IPC 11 extracts the individual data 93 from the time series data 92 in accordance with the setting information 39, and transmits the individual data 93 to the programming support apparatus 2. Upon receiving the individual data 93 from the IPC 11, the programming support apparatus 2 displays the individual data 93 on the display part 7.

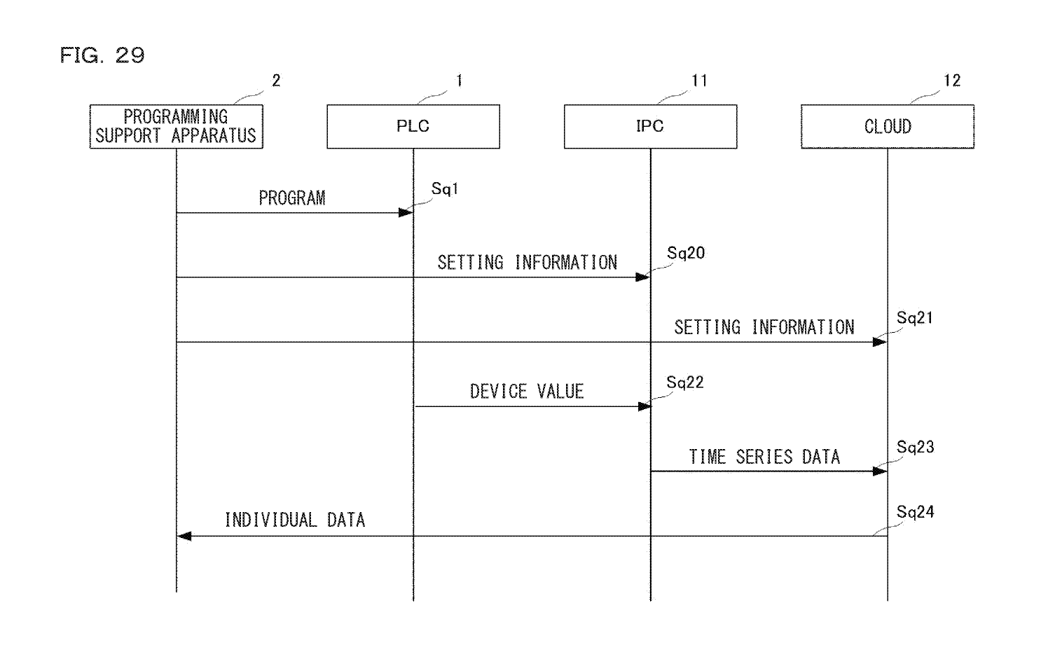

FIG. 29 shows still another sequence relative to transmission and reception of the individual data 93. In this example, the collection part 81 and the selection part 87 are mounted on the CPU 51 of the IPC 11. The acquisition part 82, the extraction part 84, the addition part 85, and the transmission part 86 are mounted on the CPU 61 of the cloud 12.

In Sq 1, the programming support apparatus 2 transmits the user program, and the PLC 1 receives this and stores this into the storage 32.

In Sq 20, the programming support apparatus 2 transmits the setting information 39 to the IPC 11, and the IPC 11 receives this and stores this into the storage 52. The setting information 39 includes information indicating the collection target device.

In Sq 21, the programming support apparatus 2 transmits the setting information 39 to the cloud 12, and the cloud 12 receives this and stores this into the storage 62. The setting information 39 includes information indicating the extraction period.

In Sq 22, the PLC 1 obtains a device value in accordance with the user program. The IPC 11 reads (receives) the device value from the PLC 1 in accordance with the setting information 39.

In Sq 23, the IPC 11 creates the time series data 92 from the collected device values and transmits the time series data 92 to the cloud 12. The cloud 12 receives the time series data 92 from the IPC 11.

In Sq 23, the cloud 12 extracts the individual data 93 from the time series data 92 in accordance with the setting information 39 and transmits the individual data 93 to the programming support apparatus 2. Upon receiving the individual data 93 from the cloud 12, the programming support apparatus 2 displays the individual data 93 on the display part 7.

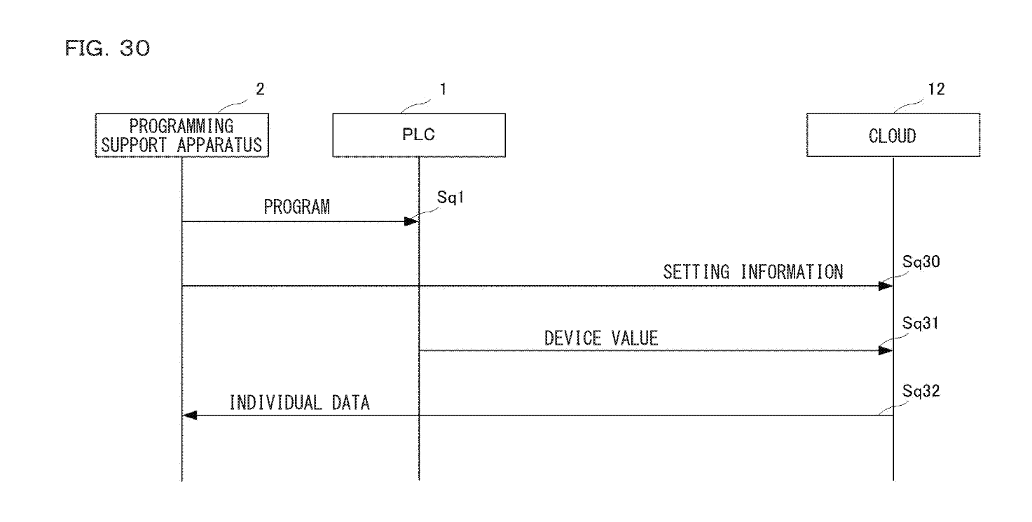

FIG. 30 shows yet another sequence relative to transmission and reception of the individual data 93. In this example, the collection part 81, the acquisition part 82, the selection part 87, the extraction part 84, the addition part 85, and the transmission part 86 are mounted on the CPU 61 of the cloud 12.

In Sq 1, the programming support apparatus 2 transmits the user program, and the PLC 1 receives this and stores this into the storage 32.

In Sq 30, the programming support apparatus 2 transmits the setting information 39 to the cloud 12, and the cloud 12 receives this and stores this into the storage 62. The setting information 39 includes information indicating the collection target device and information indicating the extraction period.

In Sq 31, the PLC 1 obtains a device value in accordance with the user program. The cloud 12 collects (reads) the device value from the collection target device of the PLC 1 in accordance with the setting information 39. The cloud 12 creates the time series data 92 from the collected device values.

In Sq 32, the cloud 12 extracts the individual data 93 from the time series data 92 in accordance with the setting information 39 and transmits the individual data 93 to the programming support apparatus 2. Upon receiving the individual data 93 from the cloud 12, the programming support apparatus 2 displays the individual data 93 on the display part 7.

### Display Result

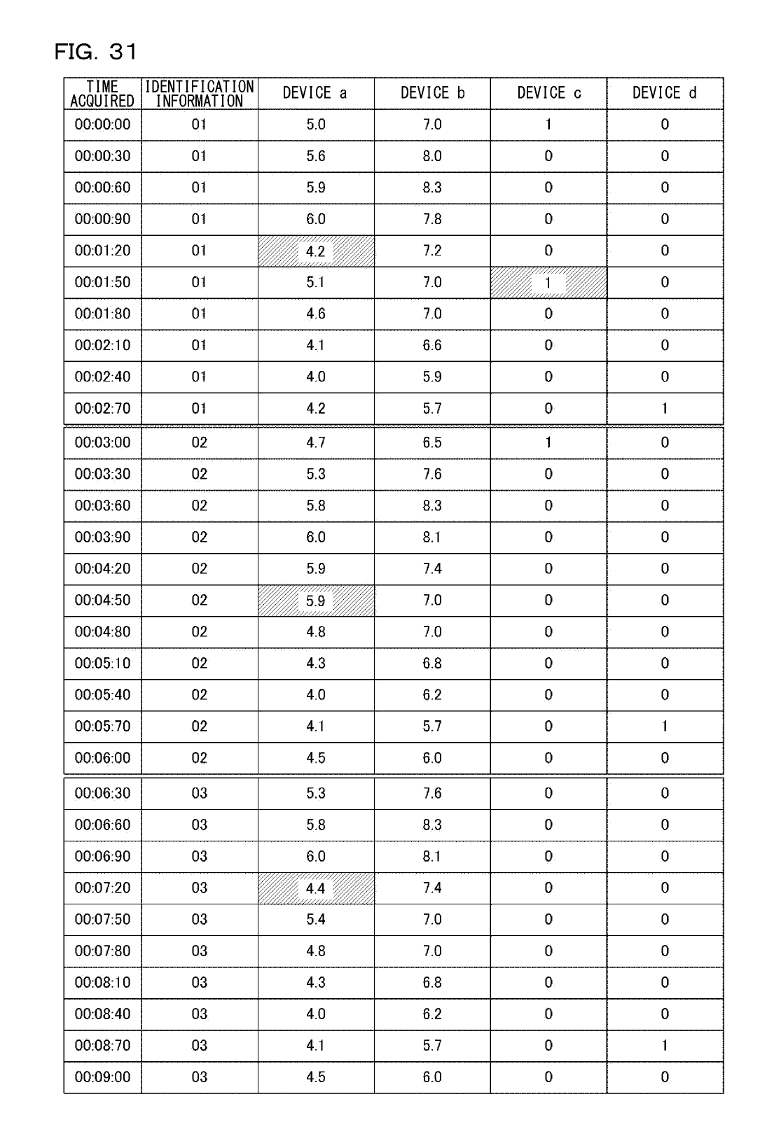

FIG. 31 shows a display example of the individual data 93. The CPU 21 (display control part 98) of the programming support apparatus 2 causes the display part 7 to display the plurality of pieces of the individual data 93. In this example, the first individual data 93 is formed of device values acquired from 00:00:00 to 00:02:70, and “01” is added as the identification information. The second individual data 93 is formed of device values acquired from 00:03:00 to 00:06:00, and “02” is added as the identification information. The third individual data 93 is formed of device values acquired from 00:06:30 to 00:09:00, and “03” is added as the identification information. The CPU 21 may compare each device value with a tolerance (threshold) and highlight a device value deviating from the tolerance. Alternatively, the CPU 21 may highlight a device value at which the completion relay is 1 at timing different from the normal timing.

In the example shown in FIG. 31, a device value c acquired at the time 00:01:50 in the first individual data 93 is determined to be NG and highlighted. The user compares the device value a acquired at the time 00:01:20, the device values a of the same phase (times 00:04:20, 00:07:20) in the second individual data 93 and the third individual data 93. The device value a acquired at the time 00:04:20 is 5.9, and the user determines that this value is an appropriate value. The device value a acquired at the time 00:07:20 is 4.4, and the user can determine that this value is an appropriate value but has almost no margin for NG 4.2. As a result, the user can determine that some countermeasure is necessary with respect to the device value a.

### Summary

Technical ideas derived from the above examples will be described. The PLC 1 is an example of a programmable logic controller that repeatedly executes a user program. Note that the PLC 1 may control inspection or processing for a plurality of parts in accordance with the user program. A part may be called a workpiece and is a term including a finished product. The storage 32 is an example of a program storage part that stores the user program. The storage 32 is an example of a device storage part instructable by the user program and holds a plurality of devices including a bit device for storing 1 bit information and a word device for storing information of one word or several words. The ladder execution part 80 is an example of a program execution part that repeatedly executes the user program stored in the program storage part and performs computing processing on information stored in each of the plurality of devices in accordance with the user program. The collection part 81 is an example of a data collection part that forms time series device data having periodicity by repeatedly collecting device data stored in at least one device. The setting part 900 and the acquisition part 82 are an example of an acquisition part that acquires an extraction period instructed by the user in the user program. The extraction part 84 is an example of an extraction part that extracts individual data from the time series device data in accordance with the extraction period acquired by the acquisition part 82. The addition part 85 is an example of an addition part that adds identification information for identifying each piece of the individual data extracted by the extraction part 84 to each piece of the individual data. As described above, according to the present embodiment, it is easy for the user to extract the individual data from the time series data.

The PLC 1 may further include a synchronization part that synchronizes execution processing for the user program in the program execution part and collection processing for the data collection part in the data collection part. For example, when the ladder execution part 80 starts executing the ladder program, the collection part 81 may start collecting the time series data.

Information instructing the extraction period may be embedded into an intermediate code of the user program generated by the intermediate language generation part 99. In this case, the acquisition part 82 acquires an extraction period from the intermediate code.

The information instructing the extraction period may be included in the setting information 39 of the user program stored in the program storage part (e.g., storage). In this case, the acquisition part 82 acquires the extraction period from the setting information stored in the program storage part.

As in “M0@R100/5 ms” which is one of the description formats, a start position and an end position of the extraction period may be defined by information (rising of R100) indicating a reference position of extraction of individual data and information (5 ms) indicating a temporal length of the extraction period. The user program may be the ladder program 36. The information indicating the reference position may be described as the timing at which a specific bit device (e.g., R100) is switched from on to off or from off to on in the ladder program. The information indicating the length of the extraction period may be described as a period before and after the timing at which a specific bit device switches from on to off or from off to on. For example, when “M0@R100/5 ms”, 10 ms which is the sum of the period of 5 ms (first half) before the rise timing of the device R100 and the period of 5 ms (latter half) after the rise timing of the device R100 is the length P of the extraction period. Information indicating the length of the extraction period may be described in association with the collection target device in the ladder program. For example, when “M0@R100/5 ms”, the collection target is device M0. As exemplified in FIG. 12, the collection target device may be all the devices described between the first description symbol and the second description symbol in the ladder program. The first description symbol (e.g., REC) and the second description symbol (e.g., END) are paired symbols.

As shown in FIG. 13, the user program may be a flowchart-format motion program. The collection target device to be collected by the collection part 81 may be every device described between the first description symbol and the second description symbol in the flowchart-format motion program. The first description symbol (e.g., REC ON) and the second description symbol (e.g., REC END) are paired symbols.

As described with reference to FIGS. 9 to 14, the input reception part 96 is an example of a receiving part that receives description of information instructing an extraction period in the user program. Similarly, the input reception part 96 is an example of a receiving part that receives description of information instructing a collection target device in the user program.

The programming support apparatus 2 may include a setting part 900 that analyzes the user program and sets an extraction period. The setting part 900 writes the information indicating the extraction period specified from the user program, together with the user program, into the program storage part 35. The extraction part 84 may extract the individual data 93 from the time series device data (time series data 92) based on the information (e.g., the setting information 39) indicating the extraction period stored in the program storage part 35.

Note that the collection part 81 may be provided in either the IPC 11, the cloud 12 or the programming support apparatus 2. The extraction part 84 and the addition part 85 may also be provided in any one of the IPC 11, the cloud 12 or the programming support apparatus 2. In this case, the IPC 11, the cloud 12, or the programming support apparatus 2 functions as a data collector.

As shown in FIGS. 24 and 25, the display part 7 may align and display the waveform of the time series device data, collected from the first device, and the waveform of the time series device data, collected from the second device, on a common time axis. As shown in FIG. 26, the display part 7 may overlap and display the waveform of the time series device data, collected from the first device, and the waveform of the time series device data, collected from the second device, on the common time axis. This will make it easier for the user to find a difference in individual data for each work. Note that the display part 7 may be provided in the programming support apparatus 2 connected to the PLC 1 and configured to support creation of a user program by the user.

The transmission part 86 is an example of a transmission part that transmits to the cloud 12 the individual data 93 to which the time series data 92 and the identification information have been added. As a result, the cloud 12 may extract the individual data from the time series data 92 or may analyze the individual data 93 in more detail. For example, the CPU 61 of the cloud 12 may compare a plurality of pieces of individual data 93 or specify individual data 93 including NG data. NG stands for no good.

The CPUs 31, 51 may store, into the storages 32, 52, data files formed of the plurality of pieces of individual data 93 to which the pieces of identification information have been added. For example, a data file in CSV format or SQL format may be created. The transmission part 86 of the CPUs 31, 51 transfers the data file to the cloud 12. The CSV format and the SQL format are mere examples, and it suffices when the format required by the cloud 12 is adopted. Further, the individual data 93 may not be stored in the data file format, but may be stored into the storages 32, 52 as a part of the time series data 92. That is, “extracting the individual data 93 from the time series data 92” naturally includes cutting the individual data 93 out of the time series data 92 or copying the same to extract the individual data 93 from the time series data 92 as data separated from the time series data 92, and also includes simply specifying a portion corresponding to the individual data 93 in the time series data 92. In this case, the individual data 93 is not separated from the time series data 92 but stored into the storages 32, 52 as a part of the time series data 92.

What is claimed is:

1. A programmable logic controller for repeatedly executing a user program, the controller comprising:
a program storage part that stores the user program;
a device storage part that holds a plurality of devices instructable by the user program and including a bit device for storing information of one bit and a word device for storing information of one word or several words;
a program execution part that repeatedly executes the user program stored in the program storage part and performs computing processing on information stored in each of the plurality of devices in accordance with the user program;
a data collection part that repeatedly collects device data stored in at least one device to form time series device data having periodicity;
an acquisition part that acquires an extraction period instructed by a user in the user program;
an extraction part that extracts individual data from the time series device data in accordance with the extraction period acquired by the acquisition part; and
an addition part that adds identification information for identifying each piece of the individual data extracted by the extraction part to each piece of the individual data.

2. The programmable logic controller according to claim 1, wherein information instructing the extraction period is embedded in an intermediate code of the user program, and
the acquisition part acquires the extraction period from the intermediate code.

3. The programmable logic controller according to claim 1, wherein information instructing the extraction period is included in the setting information of the user program stored in the program storage part, and the acquisition part acquires the extraction period from the setting information stored in the program storage part.

4. The programmable logic controller according to claim 1, wherein a start position and an end position of the extraction period are defined by information indicating a reference position for extraction of the individual data and information indicating a temporal length of the extraction period.

5. The programmable logic controller according to claim 4, wherein the user program is a ladder program, and
the information indicating the reference position is described as timing at which a specific bit device switches from on to off or from off to on in the ladder program.

6. The programmable logic controller according to claim 5, wherein the information indicating the length of the extraction period is described as a period before and after the timing at which the specific bit device switches from on to off or from off to on.

7. The programmable logic controller according to claim 4, wherein
the user program is a ladder program, and
the information indicating the length of the extraction period is described in association with a collection target device in the ladder program.

8. The programmable logic controller according to claim 7, wherein
the collection target device is every device described between a first description symbol and a second description symbol in the ladder program, and
the first description symbol and the second description symbol are paired symbols.

9. The programmable logic controller according to claim 1, wherein
the user program is a flowchart-format motion program,
the collection target device to be collected by the data collection part is every device described between a first description symbol and a second description symbol in the flowchart-format motion program, and
the first description symbol and the second description symbol are paired symbols.

10. A data collector connected to a programmable logic controller for repeatedly executing a user program, the programmable logic controller including
a program storage part that stores the user program,
a device storage part that holds a plurality of devices instructable by the user program and including a bit device for storing information of one bit and a word device for storing information of one word or several words, and
a program execution part that repeatedly executes the user program stored in the program storage part and performs computing processing on information stored in each of the plurality of devices in accordance with the user program,
the data collector comprising:
a data collection part that repeatedly collects device data stored in at least one device to form time series device data having periodicity;
an acquisition part that acquires an extraction period instructed by a user in the user program;
an extraction part that extracts individual data from the time series device data in accordance with the extraction period acquired by the acquisition part; and
an addition part that adds identification information for identifying each piece of the individual data extracted by the extraction part to each piece of the individual data.

11. The data collector according to claim 10, wherein the data collector is a server constituting a cloud.

12. A programming support apparatus for supporting a user creating a user program that is repeatedly executed in the programmable logic controller according to claim 1, the apparatus comprising:
a display part that displays the user program;
a reception part that receives description of information instructing the extraction period in the user program; and
a transfer part that transfers the user program to the program storage part of the programmable logic controller.

13. The programming support apparatus according to claim 12, further comprising
a generation part that generates an intermediate code from the user program,
wherein the generation part embeds the information instructing the extraction period into the intermediate code.

14. The programming support apparatus according to claim 12, further comprising
a setting part that analyzes the user program to acquire the information instructing the extraction period and generates setting information including the information instructing the extraction period,
wherein the transfer part transfers the setting information together with the user program.

15. The programming support apparatus according to claim 13, wherein a start position and an end position of the extraction period are defined by information indicating a reference position for extraction of the individual data and information indicating a temporal length of the extraction period.

16. The programming support apparatus according to claim 15, wherein
the user program is a ladder program, and
the information indicating the reference position is described as timing at which a specific bit device switches from on to off or from off to on in the ladder program.

17. The programming support apparatus according to claim 16, wherein the information indicating the length of the extraction period is described as a period before and after the timing at which the specific bit device switches from on to off or from off to on.

18. The programming support apparatus according to claim 13, wherein
the user program is a ladder program, and
the information indicating the length of the extraction period is described in association with a collection target device in the ladder program.

19. The programming support apparatus according to claim 18, wherein
the collection target device is every device described between a first description symbol and a second description symbol in the ladder program, and
the first description symbol and the second description symbol are paired symbols.

20. The programming support apparatus according to claim 13, wherein
the user program is a flowchart-format motion program,
the collection target device to be collected by the data collection part is every device described between a first description symbol and a second description symbol in the flowchart-format motion program, and
the first description symbol and the second description symbol are paired
